(19) United States
(12) Patent Application Publication
(10) Pub. No.: US 2024/0078919 A1
(43) Pub. Date: Mar. 7, 2024

(54) SYSTEM AND METHOD FOR DETERMINING A ROUTE OF AN UNMANNED AERIAL SYSTEM

(71) Applicant: Pattent, LLC, Atlanta, GA (US)

(72) Inventor: Jeffrey Thomas Pattison, Atlanta, GA (US)

(73) Assignee: Pattent, LLC, Atlanta, GA (US)

(21) Appl. No.: 18/243,072

(22) Filed: Sep. 6, 2023

Related U.S. Application Data
(60) Provisional application No. 63/404,258, filed on Sep. 7, 2022.
(60) Provisional application No. 63/503,234, filed on May 19, 2023.

(51) Int. Cl. G08G 5/00; G01C 21/20

(52) U.S. Cl. CPC G08G 5/0069; G01C 21/20; G08G 5/0026; G08G 5/0039; G08G 5/0086

(57) ABSTRACT

In some aspects, a method for determining a route by an unmanned aerial system (UAS) is described, the method including: receiving at least two locations, a first location and a second location; receiving UAS characteristics and spatial data; outputting a map based on the UAS characteristics and the spatial data, the map indicating a fatality rate; and outputting the route for the UAS to fly from the first location and the second location based on the map indicating the fatality rate. In some aspects, the spatial data can include at least one of: a social media activity; a density population; an area of one or more buildings; and a height of the one or more buildings. In some aspects, the route can be configured to be modified in response to at least one of safety or urgency.

### CROSS-REFERENCE TO RELATED PATENT APPLICATIONS

This application claims priority to commonly assigned and U.S. Patent Applications No. 63/404,258, filed Sep. 7, 2022, titled “Using Social Media Data to Assist in the Risk Estimation and Route Planning of Aerial Vehicles,” and No. 63/503,234, filed May 19, 2023, titled “Using Machine Learning and Artificial Intelligence Techniques to Assist in the Risk Estimation and Route Planning of Aerial Vehicles,” the disclosures of which are hereby incorporated by reference in their entireties.

### BACKGROUND

The use of Unmanned Aerial Systems (UASs) is growing in a variety of industries, including site inspections, law enforcement, and logistics. For example, the UAS can be used for delivery achieving lower cost of shipping, faster deliveries, fewer emissions, and/or shorter routes. The UAS can be used as a first responder achieving quicker response time, cost savings in comparison to sending an officer, it can also provide important information to other responders. The UAS can be used in construction and inspections to relatively easily inspect hard to reach infrastructure, and/or quickly assess damages for insurance claims.

However, governmental regulatory agencies, e.g., the Federal Aviation Administration (FAA), impose strict regulations to operation of the UAS to ensure safe operations. These regulations include payload and weight limits, restrictions on operating in airspace near airports, pilot requirements, and limitations on operating a manned aircraft and/or having sustained flights over people or beyond the visual line of sight. Although waivers can be obtained to bypass some of these restrictions, there is a pressure from industry for the FAA to repeal some of the restrictive regulations, allowing for more autonomous UAS operations. As UAS autonomy increases and the role of human pilots diminishes, more safety measures are required to ensure the UAS can operate safely without pilots. These safety measures can include hardware or software changes, or revision in the UAS concept of operations and mission planning. Density of population frequently changes during 24 hours of the day, and it affect a fatality rate. Typical models to develop the UAS routes may be slow to accommodate such dynamic changes of the population density.

### SUMMARY OF THE INVENTION

Systems and methods described in the present disclosure use machine learning and artificial intelligence techniques to estimate ground risk from an aerial vehicle. The system can include a multilayer perceptron and a convolutional neural network, both of which can be combined to estimate a ground risk metric using different types of data as input. Such method for risk estimation can be used to create a risk map for an area of interest highlighting the high risk and low risk areas. The method can be used to evaluate the risk of given locations, such as the waypoints in a predetermined route. The method can be used to facilitate the route planning for the aerial vehicle. The method can be implemented in a user interface (UI) such that a user can input the relevant input information for the machine learning model. In some embodiments, the method can be implemented via an application programming interface (API) without a user interface.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In some embodiments, the system for determining the UAS route can combine various sources of data, including but not limited to social media activity, in order to estimate the risk or danger of an aerial vehicle during flight and to use such risk estimation to facilitate creation of a route or path from a first location to a second location and/or determine the way points. In some embodiments, the system can use the social media activity data to obtain an approximation for population density to estimate risk of using an aerial vehicle. In some embodiments, the system can use the social media information to facilitate determination of a suitable path for the aerial vehicle to undertake. In some embodiments, the system can use machine learning and artificial intelligence methods to quantify and estimate the risk aerial vehicles pose to people and objects on the ground. In some embodiments, the system can use the machine learning and artificial intelligence methods to assist in the route planning of an aerial vehicle and to estimate the risk an aerial vehicle has for a given route.

In one general aspect, a method for determining a route by an unmanned aerial system (UAS) may include receiving at least two locations, a first location and a second location; receiving UAS characteristics and spatial data; outputting a map based on the UAS characteristics and the spatial data, the map indicating a fatality rate; and outputting the route for the UAS to fly from the first location and the second location based on the map indicating the fatality rate. Other embodiments of this aspect include corresponding computer systems, apparatus, and computer programs recorded on one or more computer storage devices, each configured to perform the actions of the methods.

Implementations may include one or more of the following features. The method may include implementations where the route is configured to be modified in response to at least one of safety or urgency. The method may include implementations where the route is configured to be modified in response to at least one of a social media activity, a density population, an area of one or more buildings, and a height of the one or more buildings. The method may include implementations where the UAS characteristics may include at least one of a mass of the UAS a front area of the UAS, a speed of the UAS, and the altitude of the UAS. The method may include receiving elevation data. The method may include modifying the output route based on the elevation data. The method may include implementations where at least one of the locations, the UAS characteristics or the spatial data is configured to be defined by a user. The method may include implementations where the route is configured to be displayed on a user interface (UI). The method may include implementations where the fatality rate is based at least on one of: an area exposed to an impact to a ground from a failure of the UAS or a probability of a fatality. The method may include implementations where the probability of the fatality is based at least on one of: energy during the impact to the ground from the failure of the UAS or a sheltering factor. The method may include implementations where the sheltering factor is based at least on one of: one or more trees or one or more buildings. Implementations of the described techniques may include hardware, a method or process, or a computer tangible medium.

In one general aspect, a system for determining a route by an unmanned aerial system (UAS) may include one or more processors configured to receive at least two locations, a first location and a second location; receive UAS characteristics and spatial data; output a map based on the UAS characteristics and the spatial data, the map indicating a fatality rate; and output the route for the UAS to fly from the first location and the second location based on the map indicating the fatality rate. Other embodiments of this aspect include corresponding computer systems, apparatus, and computer programs recorded on one or more computer storage devices, each configured to perform the actions of the methods.

Implementations may include one or more of the following features. The system may include implementations where the route is configured to be modified in response to at least one of safety or urgency. The system may include implementations where the route is configured to be modified in response to at least one of a social media activity, a density population, an area of one or more buildings, and a height of the one or more buildings. The system may include implementations where the UAS characteristics may include at least one of a mass of the UAS, a front area of the UAS, a speed of the UAS, and an altitude of the UAS. The system may include implementations where at least one of the locations, the UAS characteristics or the spatial data is configured to be defined by a user. The system may include implementations where the route is configured to be displayed on a user interface (UI). Implementations of the described techniques may include hardware, a method or process, or a computer tangible medium.

In one general aspect, a non-transitory computer-readable medium storing a set of instructions for determining a route by an unmanned aerial system (UAS), the set of instructions having: one or more instructions that, when executed by one or more processors of a device, cause the device to: receive at least two locations, a first location and a second location; receive UAS characteristics and spatial data; output a map based on the UAS characteristics and the spatial data, the map indicating a fatality rate; and output the route for the UAS to fly from the first location and the second location based on the map indicating the fatality rate. Other embodiments of this aspect include corresponding computer systems, apparatus, and computer programs recorded on one or more computer storage devices, each configured to perform the actions of the methods.

Implementations may include one or more of the following features. The non-transitory computer-readable medium where the route is configured to be modified in response to at least one of safety or urgency. The non-transitory computer-readable medium where the spatial data may include at least one of a social media activity, a density population, an area of one or more buildings, and a height of the one or more buildings. Implementations of the described techniques may include hardware, a method or process, or a computer tangible medium.

### BRIEF DESCRIPTION OF THE DRAWINGS

FIG. 1 illustrates a flowchart to generate a UAS route meeting user requirements;

FIG. 2 illustrates various descent trajectories of a UAS failure;

FIG. 3 illustrates a diagram of a method to determine a fatality rate for a given location;

FIG. 4 illustrates a flow diagram of a process for estimating risk and creating a UAS route;

FIG. 5 illustrates a flow diagram of a process for estimating risk and creating a UAS route using a machine learning model;

FIG. 6 illustrates a risk map and bounding box for area of interest;

FIG. 7 illustrates arbitrary start and end points specified by a user;

FIG. 8 illustrates a comparison of two route solutions with a high urgency;

FIG. 9 illustrates a comparison of two route solutions with a low urgency;

FIG. 10 illustrates factors affecting a fatality rate;

FIG. 11 illustrates a population density distribution during daytime;

FIG. 12 illustrates a population density distribution during nighttime;

FIG. 13 illustrates social media activity generated during a festival on a specific day around 10:40 am;

FIG. 14 illustrates social media activity generated during a festival on a specific day around 8:30 pm;

FIG. 15 illustrates LandScan® population density estimates;

FIG. 16 illustrates social media activity population density estimates;

FIG. 17 illustrates recorded building layouts for a specific location;

FIG. 18 illustrates a plurality of probable impact locations for a UAS;

FIG. 19 illustrates a flowchart for the machine learning model;

FIG. 20 illustrates an example architecture for a machine learning model to estimate a risk;

FIG. 21 illustrates population density data extracted for one location of interest;

FIG. 22 illustrates building data extracted for one location of interest;

FIG. 23 illustrates collection of spatial data for a plurality of cases at various locations;

FIG. 24 illustrates raw data of expected fatality rates collected from the physics-based model for 248,000 cases;

FIG. 25 illustrates filtered data of 15,524 data points;

FIG. 26 illustrates training loss and validation loss of the machine learning model;

FIG. 27 illustrates a risk map created using the machine learning model;

FIG. 28 illustrates a risk map created using the physics-based model;

FIG. 29 illustrates a risk map created using the machine learning model for a low risk UAS;

FIG. 30 illustrates a risk map created using the machine learning model for a high risk UAS;

FIG. 31 illustrates a comparison of the routes created using the machine learning risk map and the physics-based model risk map;

FIG. 32 is a risk map from physics-based model;

FIG. 33 is a risk map from machine learning model;

FIG. 34 illustrates a comparison of the UAS route based on physics-based model and the machine learning model;

FIGS. 35 and 36 illustrate a comparison of routes generated for different UAS conditions;

FIGS. 37 and 38 illustrate a comparison of routes generated for different levels of desired safety;

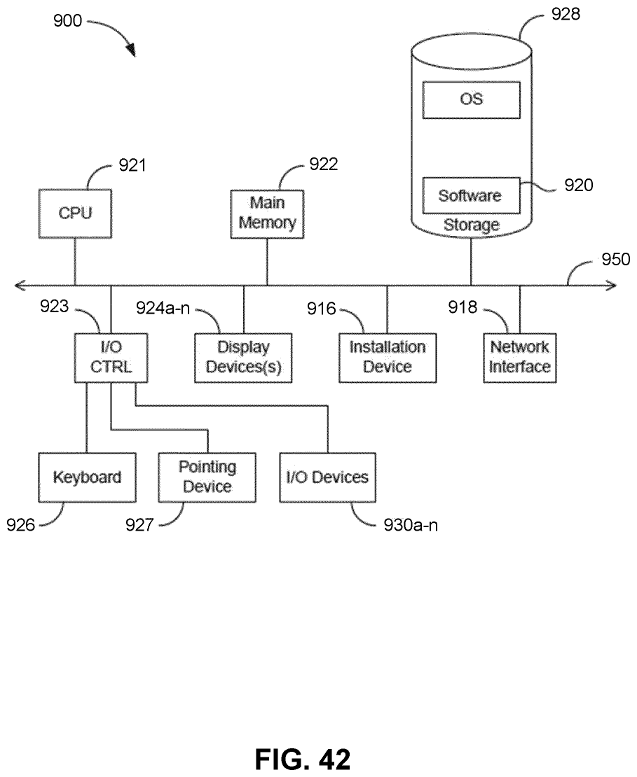

FIG. 35 is a route planned for a high risk UAS;

FIG. 36 is a route planned for a low risk UAS;

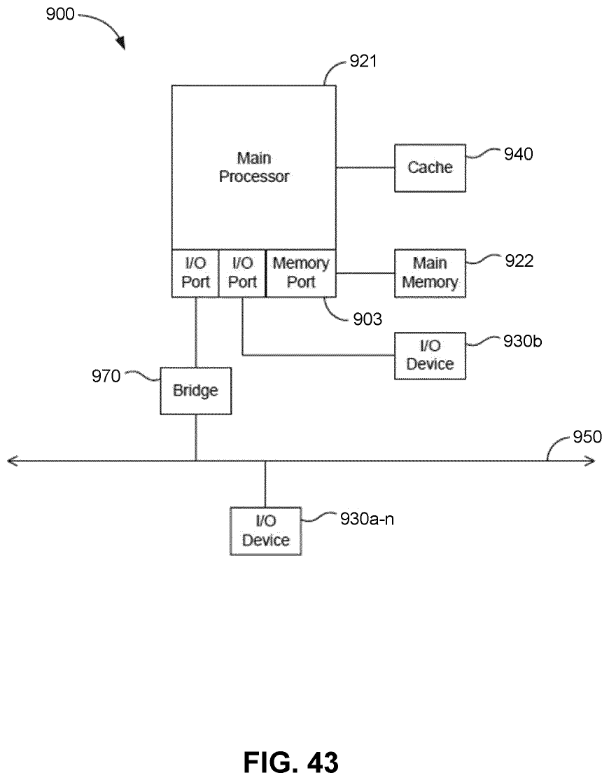

FIG. 37 is a route planned with maximum risk level 10⁻⁷ fatalities per flight hour;

FIG. 38 is a route planned with maximum risk level 10⁻⁵ fatalities per flight hour;

FIGS. 39 and 40 illustrate implementations of the system for determining a route of a UAS;

FIG. 41 is a block diagram depicting an embodiment of a computing environment including one or more access points in communication with one or more wireless devices or stations; and

FIGS. 42 and 43 are block diagrams depicting embodiments of computing devices useful in connection with the methods and systems described herein.

### DETAILED DESCRIPTION

Public interest in UAS has grown as they are being adopted to complete an increasing number of tasks, ranging from surveillance to mapping. Safety concerns around the use of UAS have slowed the adoption of the UAS into the national airspace (NAS). As a result, the process of UAS adoption has been incremental, where rules and regulations are slowly relaxed or repealed. Some of the more restrictive regulations forbid operating beyond visual line of sight (BVLOS) and substantially forbid operating over groups of people. While obtaining waivers to operate BVLOS are available, the ability to operate over people is heavily regulated due to safety concerns. Hence, these requirements hinder UAS use in urban areas in dynamic and highly populated areas.

Urban areas can benefit from the capabilities of the UAS. Such benefits include decreasing response time from first responders, improving logistics for shipping food and goods, and/or delivering medical supplies in record times. However, the heavily populated areas have made UAS use difficult having the current regulations. Currently, the FAA states the ability to fly over people varies depending on the risk levels a UAS presents to the people below, a revision of the current regulations can be required in order to exploit the full benefits of UAS. This change may not occur until there is a sufficient reason to believe the use of UAS in these populated areas is safe. A realistic and detailed risk analysis for UAS is needed to ensure UAS operation over people does not exceed an acceptable level of risk.

Current aviation practices require risk assessment to determine the likelihood and severity of accidents. If the likelihood of an accident is too high, or if the consequences of an incident are too severe, then the risk level is deemed to be unacceptable. Due to a relatively long history of manned aircraft, historical flight data can be used to estimate failure rates and safety metrics to determine probability and severity of a failure. The historical flight data can be leveraged to assess risk and determine if an aircraft is operating within an acceptable target level of safety. Unlike the manned aircraft, the UAS does not have large volume of historical flight data to use to assess risk levels. As a result, modeling and simulation methods can be used to quantify the risk of the UAS by approximating the expected fatality rates, measured in, e.g., fatalities per flight hour. Other risks of the UAS can include risk of physical harm to people, livestock, etc. or damaging valuable structures (e.g., buildings) or property. Typical methods for estimating the UAS ground risk rely on physics-based models to determine the descent trajectory for a UAS given a failure and determine the likelihood of causing a fatality if the UAS strikes a person. For example, typical methods for estimating the ground risk of a UAS failure at a given location involve approximating the failure rate, determining the probable impact locations using the laws of physics given a failure event, and then approximating the probability of a UAS causing a fatality or physical harm given the impact location. For example, the probability of causing a fatality based on impact can depend on the kinetic energy of the vehicle, the population density of the impact area, and the presence of a possible shelter, e.g., buildings and/or trees, which may provide some protection from the UAS fall. This approach is probabilistic in nature due to uncertainties in the initial UAS state when estimating the impact locations, requiring several descent trajectories to be simulated. As a result, using this physics-based approach to approximate ground risk for a single location can be time consuming. Such process can become computationally expensive and may not be suitable for dynamic environments like cities.

Surrogate modeling is a typical way to approximate computationally expensive or time-consuming processes. Examples of surrogate models include response surfaces, K-nearest neighbor, random forest, and neural networks. For example, a machine learning approach can rely on data created from the physics-based method. The machine learning methods are surrogate models that can replace computationally expensive models if enough data is provided for training. A risk assessment method can quantify UAS ground risk using machine learning, based on social media activity data to supplement historical data on population density estimates. Using social media data to estimate population density can be useful for identifying dynamic areas that can be high risk and substantially unaccounted for using static historical data. Using the physics-based approach, risk data can be generated with various UAS configurations at different locations, and this data can be used to train a machine learning model that incorporates UAS characteristics and the spatial distributions of population density and building coverage using such data as inputs. The machine learning approach allows a quick ground risk assessment to quantify the ground risk for given UAS flight conditions. Using such ground risk assessment, a UAS pilot can use the route planning tool proposed by the machine learning model to find a suitable route that has an acceptable level of risk based on the risk map created by the machine learning model.

Leveraging modeling and simulation to quantify the ground risk of the UAS, machine learning can be used to enhance the risk assessment by decreasing the time required to estimate risk. This time reduction allows UAS pilots to quickly evaluate risk levels for a given UAS operation, or the time reduction can be used to find the improved operation that minimizes UAS ground risk.

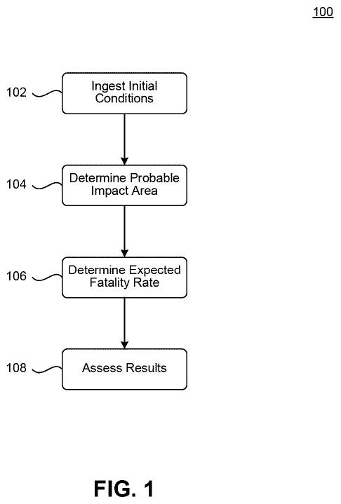

FIG. 1 illustrates a diagram of the method 100 to generate the UAS route meeting the user requirements, such as safety and/or urgency. At step 102, the system for generating the safe route ingests initial conditions. At step 104, the system, using the initial conditions, finds a probable impact area according to the equations described herein. At step 106, the system determines the expected fatality rate(s). Risk of physical harm to people, livestock, etc. or damaging valuable structures (e.g., buildings) or property can be determined in addition or a substitute of the fatality rate. At step 108, the system assesses the generated results to determine if the generated UAS route meets the requirements.

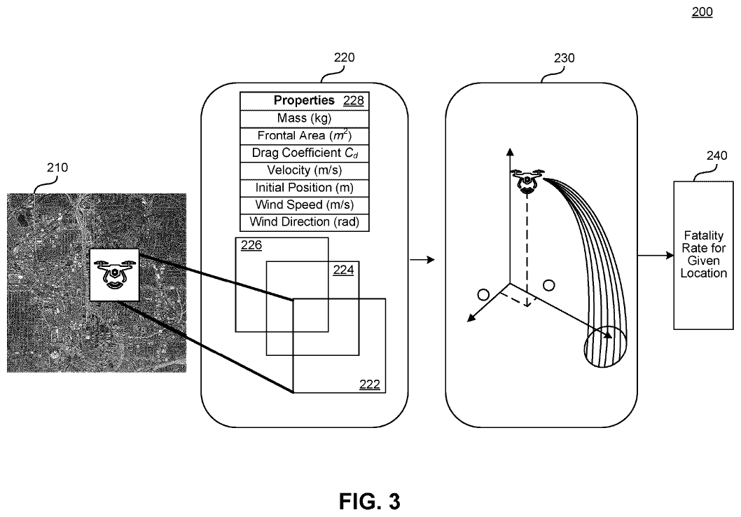

FIG. 3 illustrates a diagram of the method 200 to find fatality rate for given location. At step 210 a map of the location is provided for which the risk assessment is performed. At step 220 the data is input into the system for generating the fatality rate. For example, at step 220, the properties 228 of the UAS can be input into the system: mass (kg), frontal area (m²), drag coefficient C_{d}, velocity (m/s), initial position (m), wind speed (m/s), and/or wind direction (rad). Also, the initial conditions and surrounding information input, e.g., spatial data: a map 222 of buildings, a map 224 of vegetation, and/or population density 226. At step 230, the system determines probable impact locations. At step 240, the system generates an output that represents a fatality rate for a given location.

Safety is one of the goals of the FAA, risk evaluation and mitigation is required for manned aircraft. Due to the long history of manned aircraft, the risk assessment can be performed using historical aviation accident and incident data. Because the introduction of UAS is relatively recent compared to manned aircraft, there is an insufficient collection of data related to operations such as flight hours, number of accidents and incidents, and failure rates. The use of models and simulations is an acceptable option for UAS risk assessment. While the risk assessment for manned aircraft includes the risk to those who are onboard, UAS do not pose similar threats, so the primary risk for the UAS is to those who are in other aircrafts and to those who are on the ground.

There are several factors that can impact the ground risk levels of the UAS, including the surrounding environment and the characteristics of the UAS and its trajectory. Risk levels of the UAS can include risk of physical harm to people, livestock, etc. or damaging valuable structures (e.g., buildings) or property. The risk for a UAS can be quantified as the expected number of fatalities per flight hour, and this metric can be determined using the kinetic energy of the UAS on impact, the probability of hitting a person, and the availability of shelter that might absorb some of the kinetic energy. The typical ground risk assessment using such approach is to take a predefined UAS path and simulate different failure events along the path. For each failure event, a trajectory can be approximated using the laws of physics to estimate the most probable impact locations. For example, in the event of a power failure, a ballistic trajectory can be approximated to predict where the UAS can land. Finding the probable impact locations is needed because there is uncertainty in the UAS initial position, speed, and aerodynamic characteristics, so several descent trajectories need to be simulated. From the impact location, the kinetic energy can be determined. Combining kinetic energy with the population density, the expected fatality rate can be calculated. This process can be repeated along various points of the UAS trajectory. The risk assessment is completed for a predefined path, the safety levels for the given path may exceed the maximum level of safety and more information can be required in order to assist in the route planning phase to ensure the path of the UAS does not exceed maximum safety levels.

The approach to compile a risk map can be utilized. The risk map can identify the high-risk areas and can be used to assist in the path planning of the UAS. Using the risk map with a path planning algorithm, the UAS can be instructed to follow an improved path that reduces the ground risk. It can be accomplished by discretizing a flight zone and assessing the ground risk at substantially each discretized location for a given cruising speed and a UAS model. Using the high-fidelity probabilistic ground risk approach at substantially each location in the risk map can become time consuming and computationally expensive. In urban areas where the population density is dynamic, the ground risk map needs to be updated frequently. Such approach for ground risk assessment for unmanned rotor vehicles using a machine learning model instead of or in combination with the physics-based model enables rapid ground risk assessment. This risk assessment can then be used by a user to quantify how dangerous a UAS operation over people is and enables better decision making if a UAS mission needs to be executed. Both methods (the physics-based approach and the machine learning approach) can be used to create a risk map for a geographical location and the machine learning method accurately estimates the physics-based model.

When generating a UAS risk map relatively fast, UAS users can determine if a UAS route exceeds a maximum level of allowable risk, and the UAS users can also find a route that reduces the risk. By reducing the ground risk, an additional layer of safety can be added to the UAS operations in urban areas, if the role of the pilot is reduced. Reducing the need for a pilot benefits those who use UAS because the cost of the UAS operation is reduced. The safety measure benefits, public trust to using UAS in urban areas can be improved. By demonstrating the UAS that avoids heavily populated areas, public trust in the use of UAS can be increased.

In some embodiments, the system can combine various sources of data, including but not limited to social media activity and aerial vehicle characteristics, with machine learning and artificial intelligence methods to estimate the risk or danger to people on the ground from an aerial vehicle (e.g., the UAS) during flight, which can also be used to assist in the route planning for the vehicle.

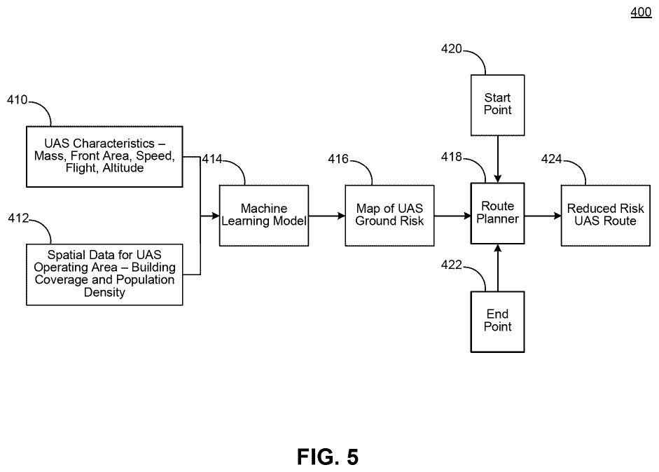

The diagram in FIG. 5 illustrates a process 400 where data is input into a machine learning algorithm 414 that can be used to estimate the risk an aerial vehicle poses to people on the ground for a given area, which can be used to facilitate the route planning. If a route has already been predetermined, then the machine learning model can be used to approximate the risk of that route. This input data can include information about the aerial vehicle and its flight conditions as well as spatial data including but not limited to building coverage, vegetation data, and population density. This machine learning model 414 can be used to quantify the ground risk for any given operating area of the aerial vehicle. To quantify the ground risk, the information can use the metric of fatalities per flight hour.

At step 410, the input information about the UAS characteristics to the machine learning model can be provided. The UAS characteristics can include aerial vehicle characteristics and flight conditions like the mass, flight speed, flight altitude, and frontal area of the aerial vehicle. This information can be obtained from the vehicle manufacturers or mission planners for the vehicle.

At step 412, additional information is acquired such as the spatial information. The spatial information can include population density estimates from social media and/or cell phone data, building coverage obtained from vegetation data or the OpenStreetMaps®, such as those supplied by OpenStreetMap Foundation of Cambridge, the United Kingdom. The form of the spatial data can include rasters and 2D arrays, with each cell in the array having a scalar value representing the data for the location of that cell.

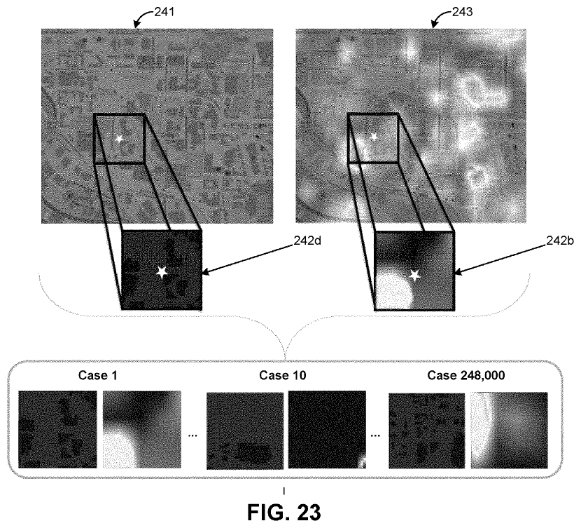

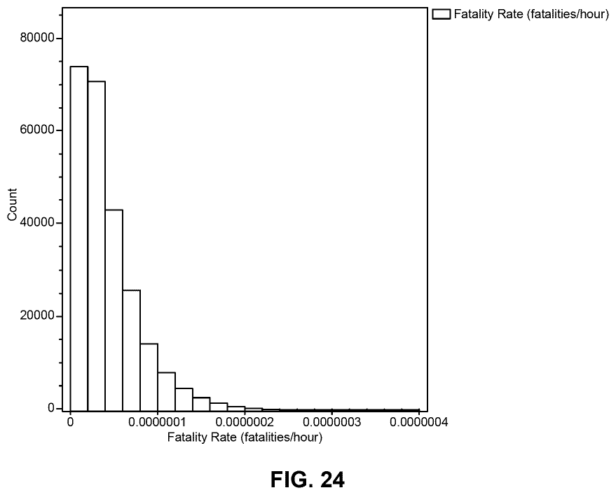

At step 414, the machine learning (ML) model can approximate the risk provided the input data. The input data for the ML model can include numeric data 510 and/or spatial data 514. An example architecture 500 of the ML model operation is shown in FIGS. 19 and 20, where both numeric and spatial data are used as inputs. In the example shown in FIGS. 19 and 20, the machine learning model is a combination of a Multilayer Perceptron (MLP) 512 and a Convolutional Neural Network (CNN) 515 to predict fatality rates. Other predicted risks of the UAS can include risk of physical harm to people, livestock, etc. and/or damaging valuable structures (e.g., buildings) or property.

The CNN 515 includes blocks 516 through 528. The MLP component 512 of the model shown in FIGS. 19 and 20 ingests the numeric data 510 as input while the CNN ingests the spatial data 514. The outputs of the MLP 512 and the CNN 515 can then be combined with additional fully connected layers 530 and 532 and a final output layer 534. The final output layer 534, for example, can be the expected fatality rate 240, measured as fatalities per flight hour, which is an example of a metric that can be used to approximate risk from an aerial vehicle. Other predicted risks of the UAS can include risk of physical harm to people, livestock, etc. and/or damaging valuable structures (e.g., buildings) or property. The architecture in FIGS. 19 and 20 is an illustrative example; there can be various model architectures that can be used to estimate a risk value. The risk value can have different forms. If a machine learning model uses data for training, similarly to how the model in FIGS. 19 and 20 undergoes training, the data to train the ML model can be ingested from different sources, including historical data of already accomplished vehicle flights or simulated data created from the physics-based models. Such data for training can be a combination of the input conditions, e.g., mass and speed, and/or the expected risk associated with the input conditions. The model, such as in FIGS. 19 and 20, can use this data to fine-tune its weights or parameters to be more accurate.

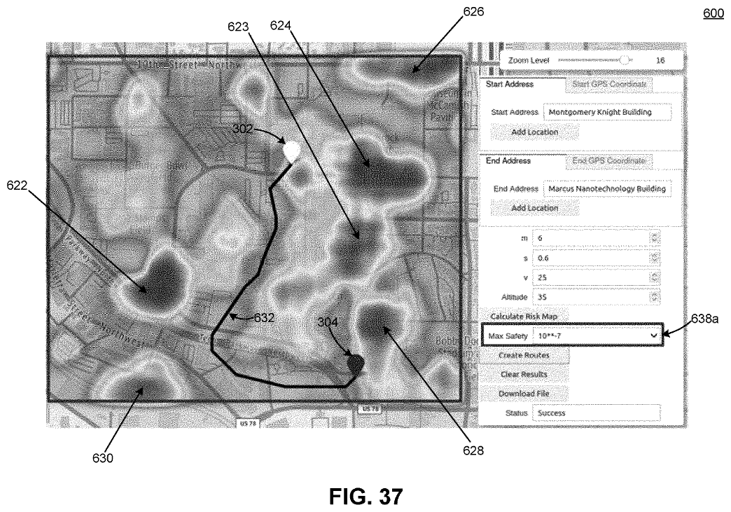

For a given area of interest or locations of interest, the machine learning model can be used to estimate the risk from an aerial vehicle. The heat map shown in FIG. 30 is an example of a heat map of the estimated risk. In FIG. 30, the heat map has units of fatalities per flight hour, with first color (e.g., red) being high risk and second color (e.g., blue) being low risk. Such heat map can be obtained by discretizing the area of interest into an array of smaller cells, where each cell corresponds to a small plot of land. The input data can be collected for each of the cells, and a machine learning model can estimate the risk for each cell. Compiling the risk values for all cells discretized in the area of interest can create a map of the risk values. If a few select locations are of interest, for example the waypoints of a route, those locations of interest can also be used for the machine learning model to estimate the risk for such locations of interest. In some embodiments, the heat maps can indicate risks of the UAS can include risk of physical harm to people, livestock, etc. and/or damaging valuable structures (e.g., buildings) or property.

After the risk for an area of interest has been determined using the machine learning model, such risk values can be fed into a route planning algorithm at step 418 to find a desirable route. For example, using a modified version of the A* algorithm, a target level of risk can be set, and the algorithm can search for a route that does not exceed the target level of risk. The machine learning model can be used to estimate the risk values while the route planning algorithm can find a suitable route.

At step 420, the start point of the route for the route planner can be provided. The start point can include a Global Positioning System (GPS) waypoint or an address. The starting point can be fed into the route planning algorithm as a location to start search for a suitable path.

At step 422, the end point of the route can be provided. The end point can include a GPS waypoint or an address. The route planning algorithm can use the end point as the terminal point when searching for a suitable path.

At step 424, the reduced (e.g., minimum) risk UAS route component that can be the route provided by the route planning algorithm using the input start point, end point, and risk calculations provided by the machine learning model. This reduced risk route can be in a form of a list of GPS waypoints and altitudes for an aerial vehicle to follow.

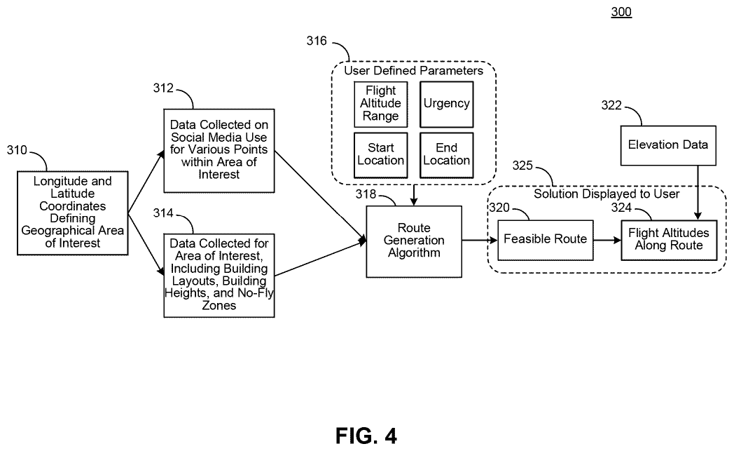

FIG. 4 illustrates a process 300 to create routes for aerial vehicles from a new area of interest defined by longitude and latitude coordinates. For a given area of interest, data can be collected and used in the route generation algorithm to find a suitable route with the user defined parameters. Having the route solution, the elevation of the land along the route is used to determine the flight altitude of the aerial vehicle along the path, ensuring the vehicle maintains an altitude above ground specified by the user.

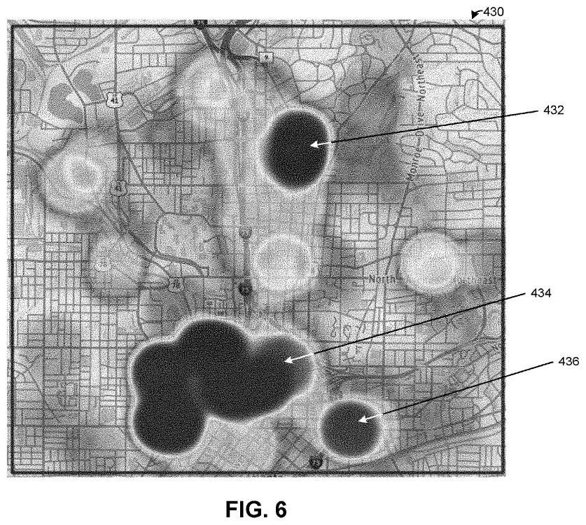

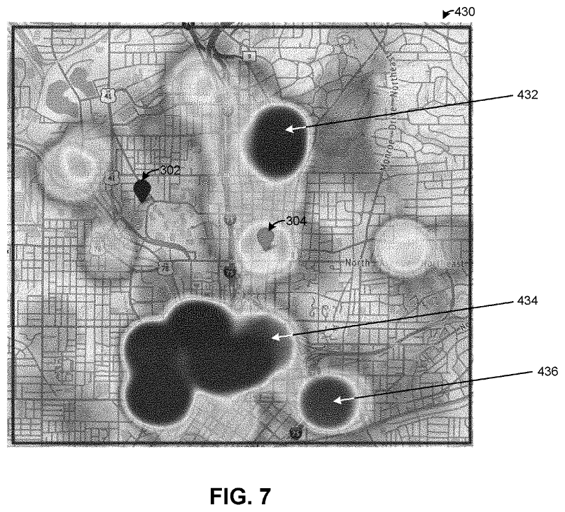

FIGS. 6-9 illustrates a bounding box 430 surrounding the area of interest. The heatmap within the bounding box 430 is the estimated risk determined from the combination of data used for risk assessment, including but not limited to the combination of building footprints and social media activity. Areas 432, 434, and 436 are the high-risk areas based on, e.g., the data collected at steps 312 and 314 (FIG. 4). Using the heat map, a user can define a first and second (e.g., start and end) locations, 302 and 304, respectively as illustrated in FIG. 7. In some embodiments, the user does not need access a user interface to access the route generation capability. Accessing the route generation capability can be done through compatible programming languages, including but not limited to Python.

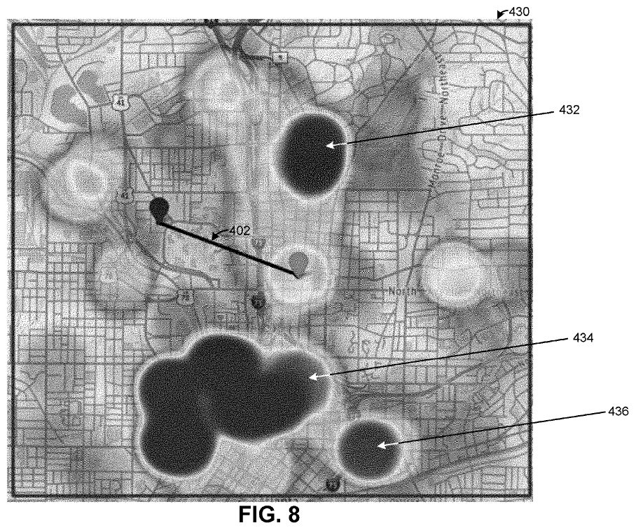

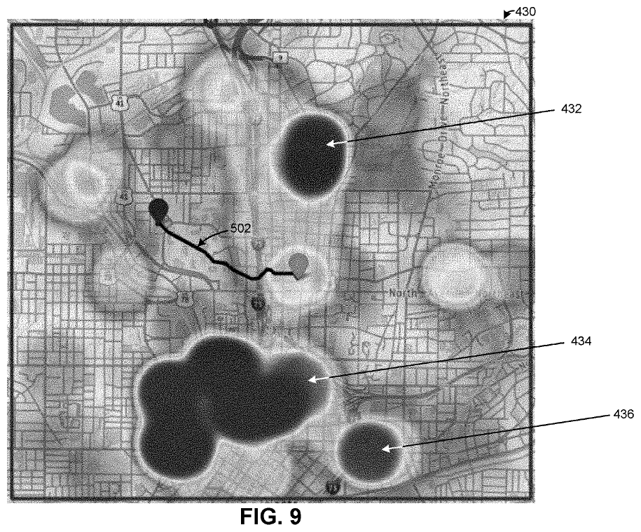

The start point 302 and the end point 304 can be specified by the user. Other user parameters can include flight altitude and urgency. After obtaining the user parameters, the information is sent to the route generation algorithm to find a suitable routing algorithm. Depending on the urgency, different solutions may be found. FIGS. 8 and 9 comparison of a route solutions 402 and 502 for two different levels of urgency.

The route generation algorithm provides different solutions (e.g., routes 402 and 502) based on user inputs. This allows the user to have a tradeoff between total distance traveled and total risk accumulated.

At step 310 in FIG. 4, a geographical area of interest can be determined. The area of interest can be specified in the form of a pair of GPS coordinates that outline a box, or it can be in the form of several GPS coordinates that enclose a shape. For example, if the geographical area of interest is the city of Atlanta, Georgia, then a pair of GPS coordinates can be identified and used to create an imaginary bounding box around the city of Atlanta. This bounding box can be a geographical area of interest.

At step 312, data can be collected on social media use for various points within area of interest. Social media can be defined as a service, platform, or website where users communicate with one another and share media, such as pictures, videos, music, and blogs, with other users. Social media includes but is not limited to Twitter® (such as that supplied by X Corporation of San Francisco, California), Snapchat® (such as that supplied by Snap, Inc. of Santa Monica, California), Facebook®, and Instagram® (such as those supplied by Meta of Menlo Park, California). To estimate the population density for a given location, one method can be used to check the number of social media posts made within a defined radius of the given location. This process can be repeated for various GPS locations within a larger area of interest to create a map of population density. For example, to estimate the population density of a single location using the same data, a Snapchat® application can populate a Snapchat Map® (such as those supplied by Snap, Inc. of Santa Monica, California), a location and radius can be sent to the Snapchat® servers using an API to obtain information on the number of Snapchats® sent with a location tag that is within the radius of the provided location.

Population density can be one form of data that can be used to estimate risk to assist in creating routes for aerial vehicles, but other data may be added for a more thorough risk estimation. Some other forms of data include but are not limited to building footprints, building heights, regulated no-fly zones, and vegetation information.

At step 314, data can be collected for area of interest, including building layouts, building heights, and no-fly zones. The combination of data can take various forms, including but not limited to a single GeoTIFF file containing a raster array. For example, information on building footprints and building heights within a given area of interest can be obtained through open-source databases, including but not limited to, OpenStreetMap®. One format where this data can be useful is when it is represented as a raster array, where the data within the area of interest is discretized into cells to form a grid. Each cell contains a value and location corresponding to a plot of land, for example a 10 m×10 m plot of land at some GPS coordinates. If a building is located at the geolocation of a cell, the cell can assume a value of zero (0). If there is no building where a cell is located, then the cell can take a value of one (1). To account for building heights, a desired flight altitude can be specified. If a building at a given location has an undesirable height for an aerial vehicle flying at a certain altitude, the corresponding cell where this building is in a raster array can assume a value of infinity. An example of regulated no-fly zone data can be the FAA facility maps in the United States that specify the maximum altitude above ground where some aerial vehicles are permitted to fly. For a given location that can be represented as a cell in a raster array, the maximum allowable flight altitude can be determined from the FAA facility maps. This information can be incorporated by defining a flight altitude, and if the FAA facility maps specify a maximum flight altitude at a given location greater than the specified flight altitude for the aerial vehicle, then a cell in a raster array can take on a value of infinity. Relevant information on the vegetation that would impact the risk estimation could include vegetation type and height, and this information can be obtained from sources such as LandFire® (such as those supplied by Landscape Fire and Resource Management Planning Tools of Washington, D.C.) that have a downloadable content.

The route generation allows user defined parameters (entered at step 316), including but not limited to the start location 302, the end location 304, the desired range of flight altitudes, and the urgency of the aerial vehicle flight. The start and end locations 302, 304 can be defined as street addresses or GPS coordinates, for example. The user can specify the desired flight altitude to occur, for example, at only 400 ft, and that the flight is not urgent.

At step 318, after the desired algorithmic parameters and the data collected, the route generation algorithm can find a suitable solution. Route generation algorithms can include but are not limited to A* and its variants, Rapidly-Exploring Random Trees (RRT) and its variants, or any combination of the like algorithms. These algorithms can be used to find an improved route based on some heuristic function. For example, an A* algorithm can be used to find an optimal route using a raster array and heuristic functions. In the A* algorithm, the algorithm can reduce the heuristic function. This raster array can be a combination of data used to estimate the risk. The heuristic function of the A* algorithm can be a heuristic function based on distance, where the distance comprises the distance traveled by the aerial vehicle from the start point 302 combined with the distance remaining from the aerial vehicle's location to the end point 304. A heuristic function can be based on a risk value. For a risk heuristic, the risk can be estimated using the data collected as a raster array. In some embodiments, the system can determine a risk value for each cell in a raster array that depends on the value of the cell in the raster array combined with the estimated population information collected based on the social media activity. For example, higher cell values and higher population densities can increase the risk value, so cells with high population or with values of infinity have high risk. The heuristic functions can be combined to create a new heuristic function for the algorithm. For example, the distance and risk heuristic functions can be combined to form a weighted average, where changing the parameters of the heuristic function can change the emphasis of a component of the heuristic function being emphasized. In this example, changing a user defined parameter for urgency can place higher emphasis on either the distance heuristic or the risk heuristic.

At step 325, the solution can be displayed to a user. After obtaining the collected data and the user defined input, the obtained information is fed into the route generation algorithm that can return a suitable path at step 320. An example of the form this solution may have a list of GPS waypoints for an aerial vehicle to follow, but the solution is not limited to only GPS waypoints.

Terrain in various geographical locations around may be not flat. For an aerial vehicle to maintain a desired altitude above the ground, the aerial vehicle can change altitudes as the elevation of the terrain changes. Elevation data can be used for a given area of interest. At step 322, the elevation data may be presented, e.g., in the form of an average elevation for a plot of land having certain dimensions. An example can be in a form of the average elevations for plots of land having dimensions 30 m×30 m for the entire city of Atlanta. This information can be obtained from sources such as LandFire® or USGS® such as those supplied by U.S. Geological Survey of Washington, D.C.

For a given route, the ground elevation at points along the route can be recorded from the database(s) of ground elevation. Using this information, the recommended flight altitude for each point can be determined by comparing the ground elevation of the location where the aerial vehicle starts to the ground elevation at each point. For example, if the recommended flight altitude is 400 ft above ground and the elevation of the starting point is 900 ft above sea level, if a point along the route has an elevation of 950 ft above sea level, then the recommended flight altitude at this location is 450 ft. This information may be useful for aerial vehicles that rely on air properties to determine the current altitude. Both the route (at step 320) and the recommended flight altitudes (at step 324) are returned to the user as a solution.

A reference is now made to the physics-based model. Risk evaluation is conducted for UAS operations to safely operate above people in urban areas. Since the UAS being introduced into the airspace relatively recently, there is insufficient flight data for the UAS to make similar risk assessments as for manned aircraft. Modeling and simulation are used to estimate the UAS risk. For example, the modeling and simulation method can be used to approximate the UAS risk via a physics-based approach. The physics-based approach can be used to generate training data for a machine learning algorithm to approximate the UAS risk in a more time efficient manner.

The ground risk metric can be defined as the expected rate of fatalities, with an acceptable level of risk being 10⁻⁷ fatalities per flight hour based on equivalent levels of safety seen in the manned aircraft. This metric can also be used for ground risk assessment. In some embodiments, the ground risk metric can be defined as the risk of the UAS to cause physical harm to people, livestock, etc. and/or damaging valuable structures (e.g., buildings) or property.

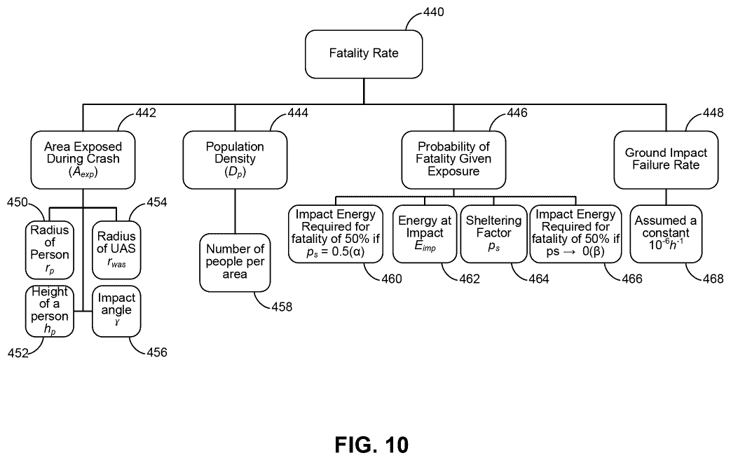

FIG. 10 illustrates factors affecting the fatality rate 440: an area exposed during crash (Aₑₓₚ) 442, a population density (Dₚ) 444, a probability of fatality given exposure 446, and a ground impact failure rate 448. Ground impact failure rate 448 is assumed to be a constant value of 10⁻⁶h⁻¹. The area exposed during crash (Aₑₓₚ) 442 can be based at least on a radius of person rₚ 450, a height of a person hₚ 452, a radius of the UAS rᵤₐₛ 454, and an impact angle γ 456. The population density (Dₚ) 444 can be based on the number of people per area 458. The probability of fatality given exposure 446 can be based on the following: an impact energy 460 required for fatality of 50% if pₛ=0.5(α); an energy at impact Eᵢₘₚ 462; an impact energy 466 required for fatality of 50% if pₛ→0(β); and a sheltering factor pₛ 464. Table 1 illustrates the sheltering factor depending on the availability of a shelter that can be an obstacle on the ground having various types of the buildings and/or vegetation.

TABLE 1

| | No | Sparse | Trees and Low | High | Industrial |
|---|---|---|---|---|---|
| Shelter | Obstacle | Trees | Buildings | Buildings | Area |
| Sheltering | 0.0001 | 2.5 | 5 | 7.5 | 10 |
| Factor pₛ | | | | | |

The equation for the expected rate of fatalities for a given location can be represented as following:

ƒ_{F}=Aₑₓₚ*Dₚ*P(fatality/exposure)*ƒ_{GIA} (1)

In equation (1), ƒ_{F} is the expected rate of casualties, Aₑₓₚ is the area exposed during the crash, Dₚ is the population density for the area of the crash, P_{(fatality/exposure)} is the probability of a fatality given the exposure, and ƒ_{GIA} is the rate of ground impact accidents.

Aₑₓₚ in Equation 1 is the area exposed to a crash for a single person on the ground. This area can be expressed using Equation 2.

Aₑₓₚ=π(rₚ+rᵤₐₛ)²sin(γ)+2(rₚ+rᵤₐₛ)(hₚ+rᵤₐₛ)cos(γ) (2)

In equation 2, rₚ is the radius of the average person, rᵤₐₛ is the radius of the UAS, γ is the glide angle of impact angle, and hₚ is the height of the average person. Using equation 2, the area exposed during a crash can be determined.

The population density of an area affects the ground risk for a UAS. Highly populated areas can result in a higher probability of a UAS striking a person in the event of an unplanned and/or uncontrolled descent. Obtaining accurate estimates on the population density information can enable a more accurate UAS ground risk assessment.

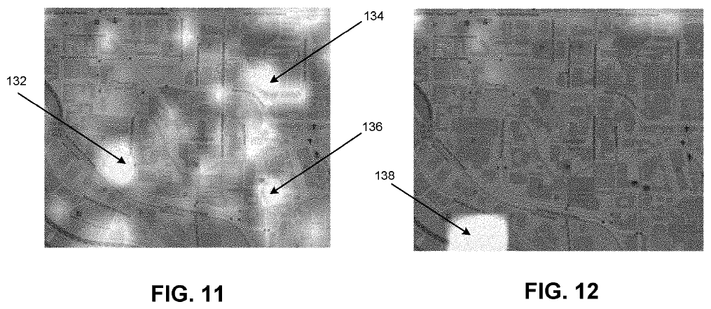

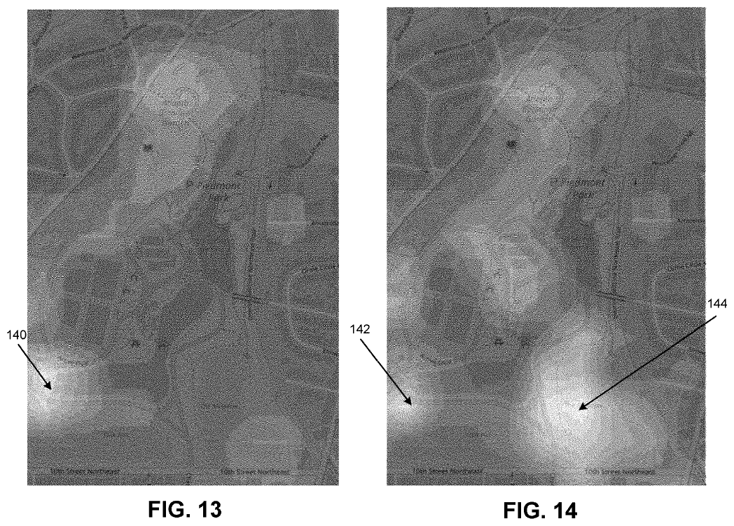

Various methods for estimating population density can be used. For example, city census data can be used to estimate the population density. The census data is readily available, but this data is static and may not be indicative to how humans move throughout the day. Census data may be outdated when it becomes available. Mobile phone data may be a resource for accurate estimates throughout the day but obtaining this data can be difficult. Accessing mobile phone data for a given area may take several days to obtain depending on the size of the area of interest. The LandScan Global Population Database®, such as those supplied by the Oak Ridge National Laboratory of Oak Ridge, Tennessee. The LandScan® database is open-source and provides high resolution (about 90 m×90 m) averages of population density throughout the day and contains population density averages for daytime and nighttime. The LandScan® database offers averages at different times of the day. FIGS. 11 and 12 illustrate a heatmap of the population density distribution at the Georgia Institute of Technology for daytime and nighttime, respectively, created using the LandScan® database. The units for the heatmap are people per square meter with each cell being approximately 10 m×10 m. For example, locations indicated with arrows 132, 134, and 136 have population density between 0.05 and 0.07. An arrow 138 shows population density between 0.07 and 0.08.

The LandScan® database can have disadvantages, for example, it can be relatively static. Because LandScan® includes historical data, it may not account for anomalous events that may result in a change in the normal expected population density. In urban areas, these anomalous events can include festivals, concerts, or parades. As a result, these occurrences need to be accounted for in order to obtain a more complete outlook of the population density (that changes any risk assessment solution used in urban areas) that LandScan® may not encompass. The use of historical data can be supplemented with monitoring population density via social media activity.

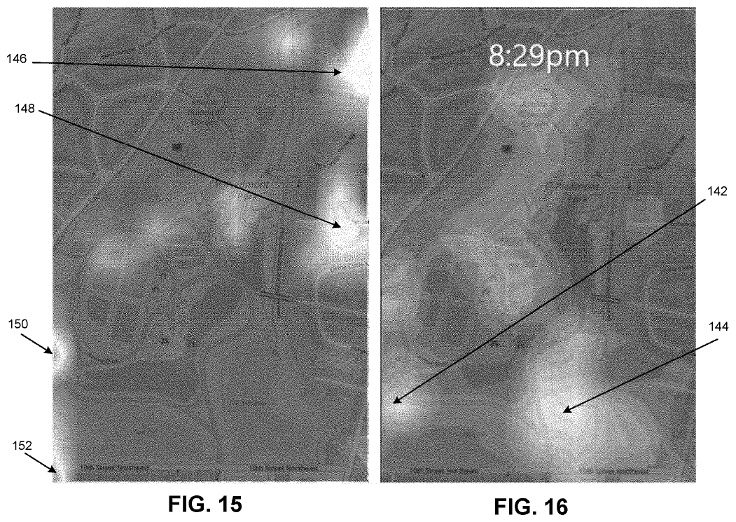

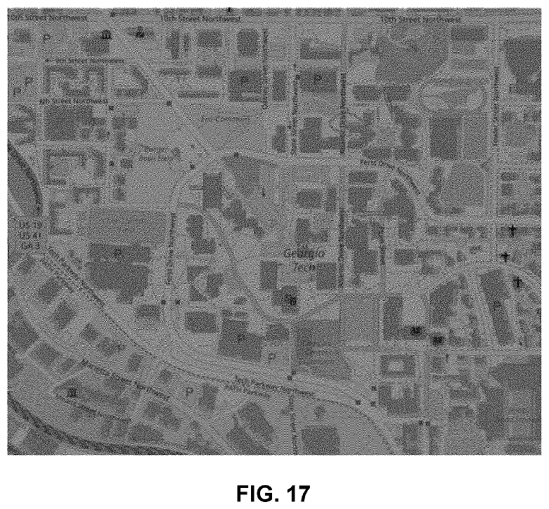

For example, a social media site Snapchat® has accessible information that can show how many posts have been made within a given radius for any given GPS location. A user can request this information for any location of interest to generate a heatmap of the Snapchat® activity. The user may gain insight regarding events that may draw many people, who may not be accounted for in the historical data for population densities. FIGS. 13 and 14 illustrate the social media activity that was generated while a festival occurred at Piedmont Park in Atlanta, Georgia. FIGS. 13 and 14 show the social media activity at Piedmont Park during different times of the day while the festival took place.

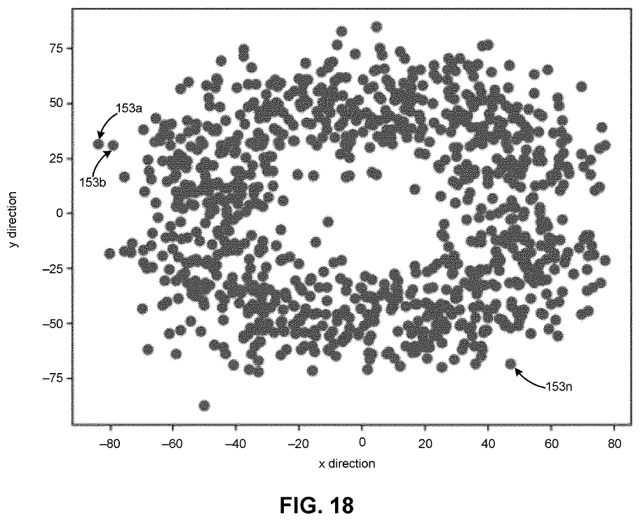

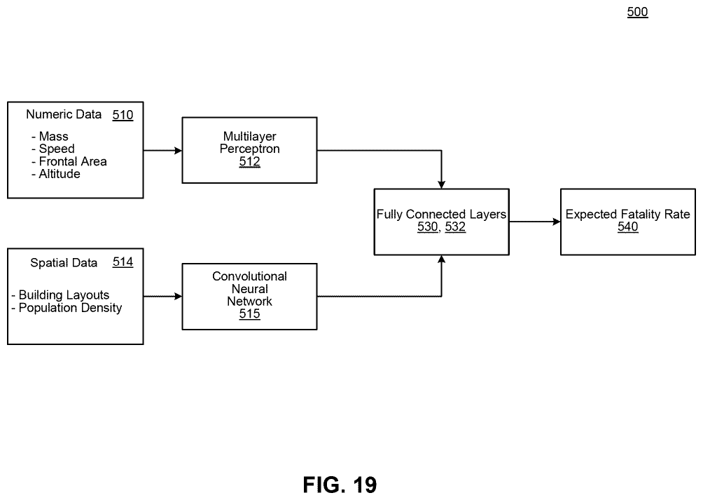

FIGS. 13 and 14 illustrate that there was more social media activity as the day progressed, suggesting there was a growing population. To show this change in population was abnormal, the social media data was compared with the LandScan® data for the same location. This comparison between LandScan® database and the social media activity is illustrated in FIGS. 15 and 16.

The discrepancy between the LandScan® population density and the collected social media data illustrates the historical data may not properly account for anomalous events like the festival at Piedmont Park. However, only the collected social media data may not be used because not everyone uses social media, and the social media is not used everywhere. Using the historical data and social media data can better illustrate population densities by utilizing the benefits of both resources. The large events that attract many people and generate social media activity can be taken into consideration while the LandScan® database can provide average estimates at other locations where sufficient social media activity is not generated.

A reference is now made the probability of fatality given exposure 446 that is the probability of a UAS strike resulting in death if it were to impact a person. The kinetic energy of the UAS on impact can be mapped to the probability of resulting in a given fatality if the UAS impacts a person. Such model takes into consideration the kinetic energy and includes a shelter factor that can provide some protection to people on the ground. The shelter factor may be different depending on, for example, if the shelter provided is a building, tree, or if the shelter is absent. The more protection a shelter may provide, the higher the shelter factor is, and the less likely a UAS accident can result in a fatality. No shelter may have a shelter factor of zero (0) while a building may have a shelter factor of five (5). The equation for finding probability of fatality given exposure, P(fatality|exposure), can be found using Equation 3.

$$P ( fatality \vert exposure ) = \frac{1}{1 + {\sqrt{\frac{α}{β}} [ \frac{β}{{E}_{imp}} ]}^{\frac{1}{4 {p}_{s}}}} \qquad ( 3 )$$

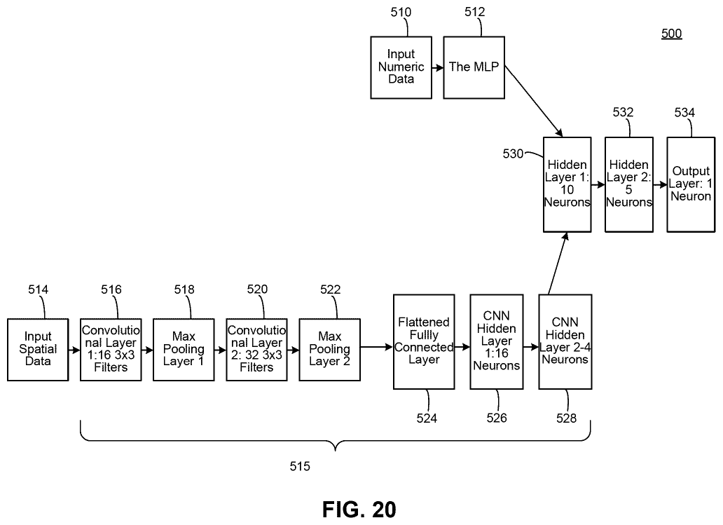

In equation 3, Eᵢₘₚ is the kinetic energy at impact and pₛ is the sheltering factor to taking into account surrounding structures that may absorb some energy. The α parameter is the impact energy required for a fatality probability of 50% with a sheltering factor of 0.5 while β is the impact energy required for a fatality as the sheltering factor goes to zero (0). Acceptable values for α and β are 100 kJ and 34 J, respectively. Common values for the sheltering factor for various types of shelter include zero (0) for no shelter, 2.5 for sparse trees, and five (5) for low buildings. The open-source database OpenStreetMap® includes information on the location of buildings that can be used for finding the shelter factor. FIG. 17 shows the building coverage layout for the Georgia Institute of Technology, with the darker color representing the buildings. Every location that did not have any building coverage was assumed to provide no shelter. Each cell in FIG. 17 is approximately 10 m×10 m.

The rate of ground impact accidents ƒ_{GIA} in equation 1, is the rate at which ground impacts occur. The rate ƒ_{GIA} is measured in number of occurrences per hour and can be based on flight history data. The value of ƒ_{GIA} can be estimated to be between 10⁻⁶ to 10⁻⁹ and can be based on the average accident rate involving unmanned aircraft. The failure rate can depend on each specific vehicle and is subject to change as vehicles become safer. A constant value of 10⁻⁶ incidents per flight hour can be used as the conservative estimate. This value can be updated and changed as better estimates are collected on the true value of the probability of the UAS failure.

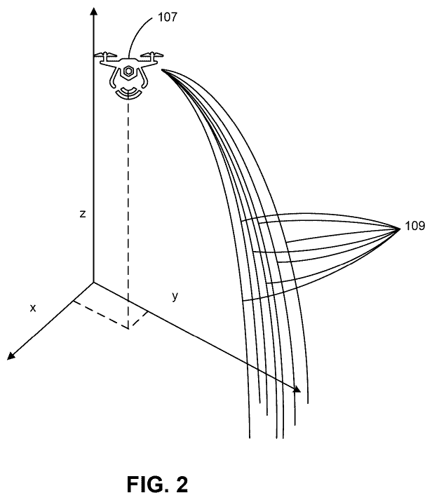

Equation 1 can be used to quantify the ground risk as expected fatality rates for a UAS in a given initial location. With the sheltering factor and population density affecting the ground risk calculation, it is important to know where a UAS is going to land. If a UAS experiences a failure event at a given location, the UAS descent trajectory can land the vehicle at a location far from where the incident occurred depending on the UAS altitude and speed. Estimating the probable impact locations of the UAS can facilitate proper ground risk assessment to identify the characteristics of its impact location, such as shelter and population density when a UAS can fail resulting in an unplanned or uncontrolled descent. Some failures include a power outage, a loss of one or more propellers for multi-rotor vehicles, or a loss of control from a pilot. Different failure types result in different descent trajectories 109 illustrated in FIG. 2.

In the physics-based model for UAS risk assessment to identify probable impact locations various mathematical models can be used to simulate trajectories for various descent types for a rotorcraft UAS: an uncontrolled glide, a parachute descent, and/or a ballistic descent. Equations 4 describe the uncontrolled glide and equations 5 describe the parachute descent. γ in the equations 4 represents an impact angle. Other symbols used for the equations 4 and 5 are described herein when the ballistic descent is described.

$$\begin{matrix}m \ddot{x} = - \frac{1}{2} p \vert \dot{x} \vert \dot{x} {C}_{d} A \\ y = γ z \\ m \ddot{z} = - \frac{1}{2} p \vert \dot{z} \vert \dot{z} {C}_{d} A - mg \\ m \ddot{x} = - \frac{1}{2} p \vert \dot{x} \vert \dot{x} {C}_{d ( parachute )} A & ( 4 ) \\ m \ddot{y} = - \frac{1}{2} p \vert \dot{y} \vert \dot{y} {C}_{d ( parachute )} A \\ m \ddot{z} = - \frac{1}{2} p \vert \dot{z} \vert \dot{z} {C}_{d ( parachute )} A - mg & ( 5 )\end{matrix}$$

The ground risk of a UAS is dominated by a ballistic descent type that may occur if power is lost when compared to other descent trajectories from other failure types. The ballistic descent can be modeled to determine the probable impact locations. The laws of physics can be used to find the probable impact locations of a UAS that loses power at some location while having a certain velocity, altitude, and physical characteristics. The equations to find the impact locations can be the following:

$$\begin{matrix}m \ddot{x} = - \frac{1}{2} p \vert \dot{x} \vert \dot{x} {C}_{d} A & ( 6 ) \\ m \ddot{y} = - \frac{1}{2} p \vert \dot{y} \vert \dot{y} {C}_{d} A & ( 7 ) \\ m \ddot{z} = - \frac{1}{2} p \vert \dot{z} \vert \dot{z} {C}_{d} A - mg & ( 8 )\end{matrix}$$

In equations 6, 7, 8, m is the UAS mass, x\ddot{ }, y\ddot{ }, z\ddot{ } are the accelerations of the UAS in the global frame where z is the altitude; ρ is the air density; C_{d} is the UAS drag coefficient; and A is the frontal area of the UAS. For a given initial location x₀, y₀, z₀ with speeds \dot{x}₀, \dot{y}₀, ż₀, the equations 6, 7, 8 can be solved for when the final altitude z_{ƒ} is zero to find the values of x_{f} and y_{f}, e.g., the UAS impact location. Uncertainty can be in the initial position, velocity, and/or drag coefficient. In order to account for the uncertainties of the initial conditions, several descent trajectories can be found that have most likely impact locations. For a given descent trajectory i, the initial conditions x₀ᵢ, y₀ᵢ, z₀ᵢ, \dot{x}₀ᵢ, \dot{y}₀ᵢ, ż₀ᵢ, and C_{di} are pulled from a normal distribution having a given mean. For example, if the probable impact locations are needed for a UAS flying with a recorded initial speed of 5 m/s at the given location, the velocities used for simulating the probable impact locations can be taken from a normal distribution centered around 5 m/s. Table 2 illustrates UAS condition parameters such as the normal distributions used for the position, velocity, and drag coefficient.

TABLE 2

| Parameter | x₀ᵢ | y₀ᵢ | z₀ᵢ | \dot{x}₀ᵢ | \dot{y}₀ᵢ | ż₀ᵢ | C_{di} |
|---|---|---|---|---|---|---|---|
| Distribution | N(x₀, 0.5) | N(y₀, 0.5) | N(z₀, 0.5) | N(\dot{x}₀, 2.0) | N(\dot{y}₀, 2.0) | N(ż₀, 2.0) | N(C_{d}, 0.2) |

To account for the UAS uncertainties, descent needs to be simulated several times, for example, 500 descent trajectories can be simulated to find the probable impact locations for a traveling UAS having given initial conditions. The uncertainties in the descent trajectory can be caused by the initial conditions of the UAS descent trajectory and impact risk level: mass (m), frontal area (A), drag coefficient (C_{d}), the UAS speed (Vₓ, V_{y}, V_{z}), the UAS position (x, y, z). In some embodiments, such initial parameters can be probabilistic. For example, parameters in Table 3 can have normal distribution with a given standard deviation.

TABLE 3

| | Drag | Horizontal | Vertical | Initial X | Initial Y | Initial Z |
|---|---|---|---|---|---|---|
| | Coefficient | Speed | Speed | Position | Position | Position |
| Property | C_{d} | (m/s) | (m/s) | (m) | (m) | (m) |
| Standard | 0.2 | 0.5 | 0.5 | 1.5 | 1.5 | 0.5 |
| Deviation | | | | | | |

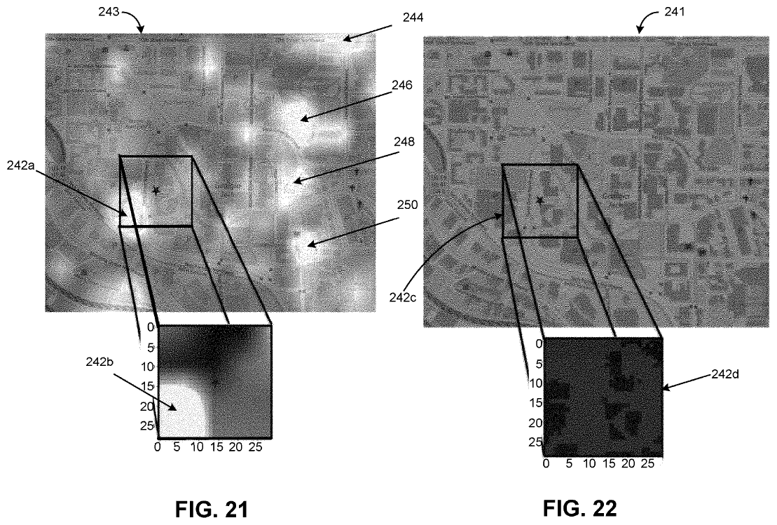

At this stage, no route for the UAS may be determined yet, and the direction the UAS travels may be not specified. To account for this condition, each of the 500 different descent trajectories is given a different heading, with the heading determined by sampling from a uniform distribution ranging between 0 and 360 degrees. FIG. 18 illustrates the results of 500 simulated descent trajectories to find the most probable impact locations for a UAS using the initial conditions. In FIG. 18, it is assumed the UAS initially starts at (0,0) with each marker 153a, 153b, . . . , 153n (including all other markers in FIG. 18 not showing the associated numerals) identifying one of the probable impact locations.

For each of the 500 trajectories simulated at a given location, the kinetic energy of the UAS, population density, and sheltering factor can be recorded at the location of the impact and can be used to find the expected fatality rate using the equations 1-3 and 6-8. After calculating 500 expected fatality rates for a given UAS starting location, the mean fatality rate of the 500 trajectories can be recorded as the fatality rate for that location having the given initial conditions. To create a risk map that can facilitate route planning, the process can be repeated at various locations. For each location within the map, the probable impact locations and expected fatality rates can be calculated. The process to generate a risk map can become time consuming as the size of the map increases. Some simplifying assumptions can be introduced for determining the probable impact location to reduce the computation time with the trade-off of losing some accuracy. However, adding simplifying assumptions can negatively affect credibility of the analysis. The machine learning methods can be used to estimate the risk in a more time efficient manner compared to the high fidelity physics-based model. The machine learning methods can learn and estimate the ground risk of UAS based on the data collected from the high fidelity physics-based model. The physics-based model can have a high fidelity while the machine learning model can be used without sacrificing the computation time to approximate relatively fast the physics-based model within some reasonable degree of accuracy.

To estimate the UAS ground risk, the UAS initial condition parameters and spatial data around a GPS location are fed into the machine learning (ML) model as inputs. The ML model can output an expected fatality rate for that given location. In some embodiments, ML model can output a risk of the UAS to cause physical harm to people, livestock, etc. and/or damage valuable structures (e.g., buildings) or property. For example, the process of outputting the expected fatality rate for that given location can be repeated at every location in an area of interest to generate a risk map. The data can be generated using the physics-based model to create a database of fatality rates mapped to the input conditions of the UAS. In such supervised learning approach, the physics-based model generates the output data, and the machine learning model can learn the pattern between the input parameters and the output fatality rate. Because the fatality rates are continuous, the machine learning algorithm can be used for regression instead of classification. Therefore, a supervised learning algorithm for regression can be used. In some embodiments, a risk of the UAS to cause physical harm to people, livestock, etc. and/or damage valuable structures (e.g., buildings) or property.

The type of input data can affect which type of machine learning algorithm can be suitable. Based on the described physics-based model, the type of input data required can be mixed between numeric and spatial data. Numeric data can include the mass, speed, frontal area, and/or altitude of the UAS. The numeric data affects the kinetic energy upon impact, and therefore affects the expected fatality rate. The sheltering factor from the surrounding coverage and the population density can affect the fatality rate. The values of the surrounding coverage and the population density are scalar. Based on the probable impact locations in FIG. 18, a single value for the surrounding coverage and/or the population density is difficult to determine because the population density and building coverage can change based on where the UAS lands. The entire area encapsulating the probable impact locations is input to accurately estimate the expected fatality rates. The machine learning model needs to account for both scalar values e.g., the UAS characteristics and initial conditions and also the spatial inputs e.g., shelter and population density. For example, as illustrated in FIGS. 19 and 20, two machine learning algorithms can be combined to account for the different input data types. A Multilayer Perceptron (MLP) 512 and a Convolutional Neural Network (CNN) 515 can be combined to account for numeric spatial data. The MLP 512 accounts for the numeric data 510 and the CNN 515 accounts for the spatial data 514. The outputs of these models 512, 515 can be combined with additional layers 530, 532 to produce a single output 534, predicting the expected fatality rate. In some embodiments, the risk of the UAS to cause physical harm to people, livestock, etc. and/or damage valuable structures (e.g., buildings) or property can be predicted.

The Multilayer Perceptron 512 is an artificial neural network (ANN) architecture and is comprised of one or more hidden layers between an input layer and an output layer. Each layer can consist of a number of neurons, and each neuron in a layer takes as input all values of the neurons in the layer before it and transforms the inputs using an activation function. These values can then be passed to all the neurons in the next layer. For typical regression applications using MLP 512, the final layer is the output layer and consists of a single neuron, which is the predicted value. The MLP 512 can have one input layer and two hidden layers. The first hidden layer can have eight neurons and the second hidden layer can have four neurons. The input parameters can be UAS characteristics and initial conditions. Because the MLP 512 can be connected to the CNN 515, the final layer has multiple neurons.

CNNs can process data with grid-like topology to learn patterns and spatial relationships. For example, images can be inputs because images can be grid-like arrays of pixels. The CNN architecture can be a combination of convolutional and pooling layers with the final layer being a fully connected layer comprised of all nodes of an input array collapsing into a single layer.

The grid-like topology input for the CNN 515 can be the building coverage and population density for a given location of interest. The input data can be in a form of two arrays, population density and building layouts, of the surrounding area of the location of the UAS. These arrays can encompass the area of land where the UAS is likely to land. The cells in the array for the building coverage can have the value of either zero (0) and one (1) where zero (0) represents shelter and one (1) represents no shelter. The values in the population density array are the number of people located per square meter. Based on the CNN architecture, a summary of the CNN 515 can be seen in FIG. 20.

The CNN 515 can have an initial convolutional layer 516 having 16 filters, a maximum pooling layer 518, a convolutional layer 520 having 32 filters and maximum pooling layer 522. The CNN 515 is flattened 524 and connected to a hidden layer 526 having 16 neurons, and last layer 528 having four neurons.

To estimate risk using the MLP 512 and the CNN 515, the two output layers of each model 512 and 515 can be concatenated together. Three additional layers can be added to the combined output: two hidden layers, one layer 530 with ten neurons and one layer 532 with five neurons, and an output layer 534 with one neuron, can be added to the model. The output layer 534 with one neuron is the predicted fatality rate 540. In some embodiments, the risk of the UAS to cause physical harm to people, livestock, etc. and/or damage valuable structures (e.g., buildings) or property can be predicted as the output layer 534.

Incorporating a ground risk assessment facilitates UAS operations in protecting people on the ground as UASs become more ubiquitous in the airspace, especially in highly populated areas. The benefit of using a machine learning model described herein over or in combination with the typically used physics-based models is the reduction in required computation time. There can be a discrepancy (or error) between the results of the machine learning model and the physics-based model. Error reduction can be accomplished by increasing the data used for training. By leveraging the physics-based model, a supply of data can be generated to train the machine learning model.

Increasing the fidelity of the physics-based model can be achieved by incorporating additional descent trajectories (e.g., the uncontrolled glide and/or parachute descent) and the effect of wind. In some embodiments, more diverse population densities and building layouts can be added to the ML training process to increase robustness of the system for determining the UAS route.

To train the machine learning model, data for the input conditions can be mapped to the output fatality rate, the physics-based model can be used to generate this data by using the initial conditions 210 of the UAS and the spatial data 514 at the UAS location to calculate an expected fatality rate 240. In some embodiments, the risk of the UAS to cause physical harm to people, livestock, etc. and/or damage valuable structures (e.g., buildings) or property can be used instead of or in addition to the fatality rate. A machine learning model used for the UAS risk assessment can handle a combination of the UAS speed, altitude, mass, frontal area, and/or velocity along with any distribution of shelter and population density, and the ML training data can reflect these combinations. It can be impractical to include a large number of these combinations when observing the common operating conditions of the UAS. A summary of the ranges used for the typical UAS characteristics is illustrated in Table 4.

TABLE 4

| Parameter | Minimum | Maximum |
|---|---|---|
| Mass (kg) | 2.0 | 9.0 |
| Frontal Area (m²) | 0.347 | 0.81 |
| Speed (m/s) | 5 | 35 |
| Altitude (m) | 15 | 140 |

The minimum limit for the mass can be selected based on difference in the probability of causing a neck injury between the 1.2 kg DJI Phantom 3® and the 3.1 kg DJI Inspire 1®, such as those supplied by DJI of Los Angeles, California. The DJI Phantom 3® has lower probability to cause a neck injury while the DJI Inspire 1® has a higher probability, so a mass of 2 kg between the DJI Phantom® and DJI Inspire® can be used as the minimum value.

After the ranges for the UAS characteristics are determined, a large number of combinations of parameters can be sampled to train a machine learning model to achieve robustness. A design of experiments was used to fully explore the design space. A Latin hypercube design of experiments can be chosen because it is a space-filling design that creates design points evenly spread throughout the design space. To ensure the design space is being thoroughly sampled, 248,000 data points of different combinations of UAS parameters can be generated. The design points of the UAS parameters can be only a portion of the data, and spatial data 214 for each of the design points can be needed.

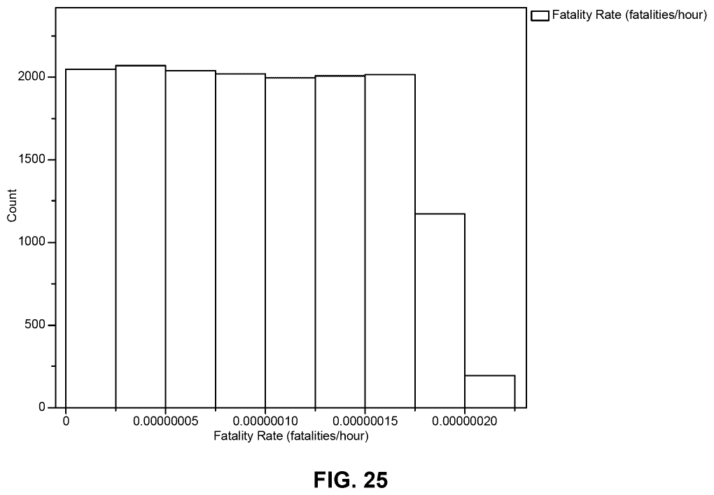

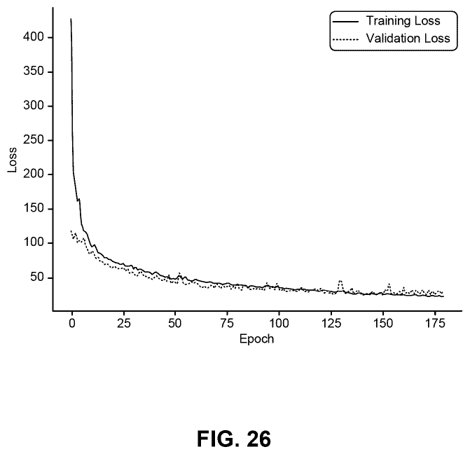

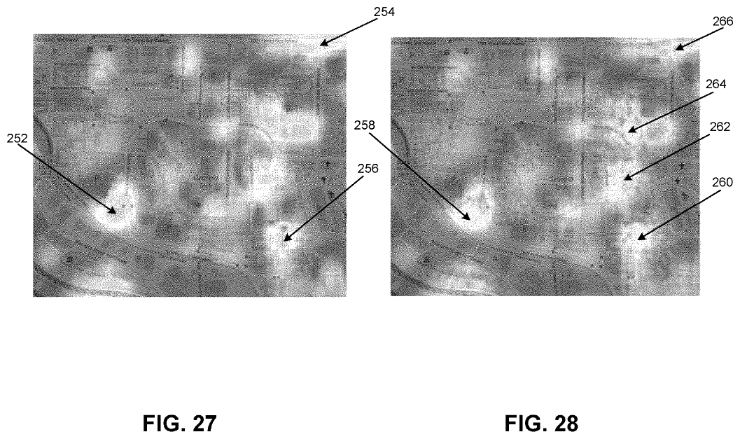

To generate the input training spatial data 514, the building coverage and population density for the Georgia Institute of Technology can be used. FIGS. 21 and 22 illustrate the spatial data being extracted for a single location of interest. For example, FIG. 21 illustrates the population density and FIG. 22 illustrates building coverage for the Georgia Institute of Technology are shown as 2D arrays, where each 10 m×10 m cell being a unique location. The total size of the array can be 113 rows and 135 columns, resulting in 15,504 unique locations. FIG. 23 illustrates collection of spatial data for a plurality of cases at various locations. For each unique location of interest 242a-242d, a 29 cells×29 cells window 241 and 243 of the building coverage and population density, respectively, can be extracted and used as the spatial input data 214 for that location of interest. In FIGS. 21 and 22, the expected fatality rate is being estimated for the location identified by the marker (represented by a star) in FIGS. 21 and 22. In some embodiments, the risk of the UAS to cause physical harm to people, livestock, etc. and/or damage valuable structures (e.g., buildings) or property can be used instead of or in addition to the fatality rate.

The areas in FIG. 21, marked with numerals 242a through 250 has larger population density in comparison to other areas in FIG. 21. To capture the effect of population density and shelter coverage on the fatality rate and the effect of the UAS conditions, 16 different UAS conditions can used at each location of interest (e.g., some of which are illustrated in FIG. 23) to utilize the data set generated using the Latin hypercube design of experiments. Table 5 illustrates the UAS characteristics for cases 1, 2, 3, and 248,000 that are obtained using the Latin hypercube design of experiments.

TABLE 5

| | | | | | Case |
|---|---|---|---|---|---|
| Property | Case 1 | Case 2 | Case 3 | . . . | 248,000 |
| Mass (kg) | 8.25 | 2.05 | 8.83 | . . . | 4.56 |
| Frontal Area | 0.41 | 0.66 | 0.70 | . . . | 0.77 |
| (m²) | | | | | |
| Horizontal | 18.38 | 14.95 | 7.29 | . . . | 5.73 |
| Speed (m/s) | | | | | |
| Initial | 24.36 | 60.30 | 70.75 | . . . | 83.95 |
| Altitude (m) | | | | | |

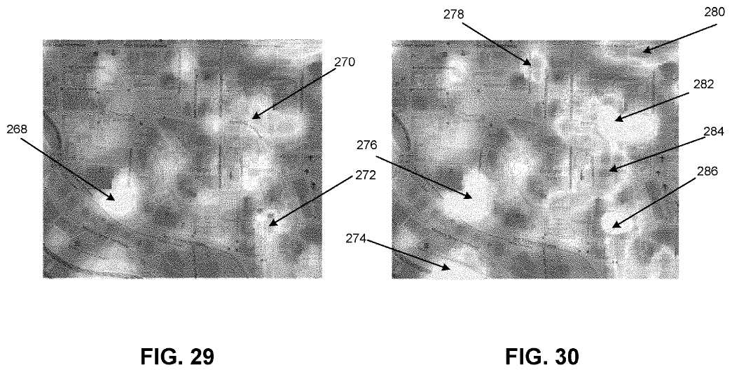

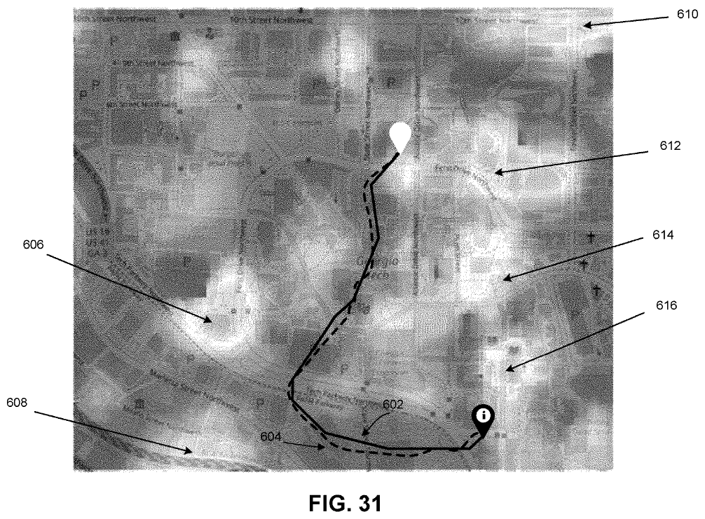

Combining the input spatial data 514 and the input numeric data 510, the physics-based model is used to estimate the expected fatality rate 540 for each of the 248,000 cases. During training of a machine learning algorithm, the data that is used for training is cleaned. After running each of the 248,000 input data points in the physics-based model to estimate the expected fatality rates, the output data can be inspected to identify any outliers that complicate the training process. The raw data distribution for the resulting fatality rates is illustrated in FIGS. 24 and 25. In some embodiments, the risk of the UAS to cause physical harm to people, livestock, etc. and/or damage valuable structures (e.g., buildings) or property can be used instead of or in addition to the fatality rate.

As illustrated in FIG. 24, the calculated fatality rates are skewed with a range from 0 to 3.8×10⁻⁷ and values reaching as low as 2×10⁻¹⁰. Machine learning algorithms training can be impaired when the data is not substantially equally represented. In FIG. 24, there are few values at the high end of the fatality rate calculation and many data points have low risk. The high risk data points are not sufficiently represented. Data points can be sampled in such a way that a more uniform distribution is output. For example, some of the outlier data points at the high end can be trimmed in order to obtain sufficient number of points for training. A more uniform distribution of the used data points is illustrated in FIG. 25. The number of data points in the distribution is 15,524, which is a down-sized from the original number of data points 248,000. The full range of the UAS input characteristics can be represented in this data set to ensure there are no gaps in the design space for training. After cleaning the data, the data can be used for the machine learning model training.

A reference is now made to hyperparameters of the machine learning model training process. The hyperparameters set for training can affect performance of the ML model. The hyperparameters include a type of a loss function, the learning rate, a batch size, and the number of epochs used for training. The loss function can be Mean Absolute Percent Error (MAPE). The batch size and number of epochs can be, for example, 128 and 200, respectively.

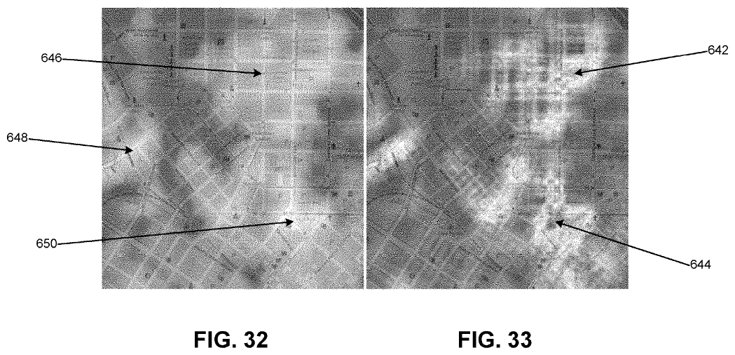

FIG. 26 illustrates a training summary of the ML model, according to some embodiments. Using the physics-based methods to generate training data, a machine learning model can be trained with a 16% error on the training data and a 22% error on the validation data. An early stop condition can be implemented to prevent the model from overfitting the training data if the testing validation accuracy stopped improving.

Other hyperparameters that affect the performance of the ML model are associated with the architecture of the ML model. For example, the number of layers or the number of neurons in each layer of the MLP 512. Changing the architecture can affect the performance of the model. Several architectures can be explored to identify a suitable model that has acceptable performance, such model can be used as the baseline and the baseline model can be fine tuned. Parameters in the baseline model architecture that are subject to change include the number of neurons in each of the MLP layers, the number of filters in the CNN convolutional layers 516-528, the number of neurons in the CNN fully connected layer(s) 530, 532, and the number of neurons in the final two fully connected layers 532, 534 after the outputs of the CNN 515 and MLP 512 have been connected. A range of each of these parameters is summarized in Table 6.

TABLE 6

| Model Parameter | Minimum | Maximum |
|---|---|---|
| MLP Hidden Layer 1 Neurons | 4 | 100 |
| MLP Hidden Layer 2 Neurons | 4 | 100 |
| Number of Filters in Convolutional Layer 1 | 4 | 32 |
| Number of Filters in Convolutional Layer 2 | 4 | 128 |
| CNN Hidden Layer 1 Neurons | 4 | 32 |
| CNN Hidden Layer 2 Neurons | 4 | 32 |
| Hidden Layer 1 Neurons | 4 | 32 |
| Hidden Layer 2 Neurons | 4 | 32 |

The machine learning model training can be performed in Python using TensorFlow®, such as those supplied by Python of Wilmington, Delaware. Another Python package, Keras® (such as that supplied by Python of Wilmington, Delaware) is compatible with TensorFlow®. One of the functionalities of Keras® is to automate a random search to find the optimal model configuration; 200 random model combinations can be generated from the ranges in Table 6 and tested. Because there is randomness in the actual training process, each model combination can be trained three different times. The model with better performance out of the 200 random combinations can be saved for future ML model operations.

In machine learning applications, brute force trial and error can be used to find a model that works. When a model does not perform adequately it can be because of poor data quality, poor hyperparameter selection, a poor selection of important factors, or a combination thereof. For example, data quality and sub-optimal model architecture can be addressed to improve the model.

The training data quality can be problematic due to distribution of the raw data for the expected fatality rates. Having a skewed distribution, several rounds to downsize the data to find sufficient number of data points can be performed without significantly reducing the total range of the data points due to the outliers. A sample of data that can be chosen can be a number of data points ranging from 10⁻⁹ to 10⁻⁸, which can be about 27,000 data points for training. The machine learning model can be suitable at estimating risk which has a true value within that range. The higher the upper limit on the maximum value of the range, the less data points are in that higher upper limit. A solution can be found by removing the top 10% of the raw data to remove the outliers and using data points that covered the entire range of the data to achieve a uniform distribution.

The data can have zero risk values collected from the physics-based model. The loss function for the machine learning model training can be the Mean Absolute Percent Error (MAPE), which has the truth value for the estimated risk in the denominator. With the truth value being zero, the equation can provide results having in very high MAPE. The solution to this case can be to put a lower limit on the fatality rates that are used for training. The floor value can be 10⁻⁹ fatalities per flight hour. Substantially anything less than this value can be deemed to be safe because it can be two orders of magnitude lower than the acceptable value of 10⁻⁷ fatalities per flight hour, and it can be more conservative to assume this higher risk value. Though the magnitude of the risk values can be small, this may not result in the MAPE being very high in comparison to when the risk was zero because all risk values can be scaled by the maximum value prior to being used for training.

The raw data generated from the physics model can appear to be heavily skewed and have an appearance of a logarithmic distribution. The output data can be scaled with a natural logarithmic and logarithmic function with base ten (10). Such scaling can provide the data a more uniform distribution, and more of the data points can be used. Initially, such data transformation can result in very low errors on both the training dataset and the validation dataset, sometimes having a less than 2% MAPE. However, this low error can provide a false sense of accuracy. When the data is log shifted to train the model, the model may do poorly when deployed to create a risk map. The predicted output from the model needs to be transformed back to non-logarithmic function so as to account for the log transformation done during training, so the same data point that is 2% during training can be around 30% to 40% off when the predicted value is transformed back.

Training the ML model on the dataset can be difficult when the orders of magnitude are different between the maximum and minimum points. To increase the performance of the ML model, the following methods can be utilized: discretizing the entire dataset range into bins and turning the regression problem into a classification problem. For example, instead of predicting the raw value for the risk, the ML model can estimate the class where a datapoint belongs, and this class can be associated with the approximate risk value for the given datapoint. Such approach may not produce a model with satisfactory accuracy regardless of the number of classes to which the data was split into for training purposes. To improve the model performance for regression, using pretrained CNNs available through TensorFlow® can be utilized.

The numeric input parameters can be reduced. The appropriate input parameters for a model can be selected. Not sufficient parameters can inhibit the ML model to learn on information that the ML lacks and too many input parameters may require a more complex model, making training more difficult. The drag coefficient can be included in the numeric data as an input for the model. However, the drag coefficient may not play a significant role in the fatality rate. The small range of the drag coefficient can attribute to the low affect that the drag coefficient can have on the risk values. The drag coefficient can be removed as an input for the model, and such removal may boost model performance.

A change in the structure of the input data and the CNN 515 can improve performance of the ML model. The spatial data input 514 captures the entire area a UAS may impact upon descent, the initial size for the input spatial data 214 can be 65 cells×65 cells, which can be equal to a plot of land about 650 m×650 m. However, the maximum distance the UAS is predicted to land can be less than 200 m away from the location of failure, therefore the initial input spatial data 514 may be too large. When the input spatial data 514 is large, the ability of the ML model to learn is hindered. Therefore, the input spatial data size can be reduced from 65 cells×65 cells to 29 cells×29 cells to ensure the entire area of the UAS impact is captured.

The baseline machine learning model and the machine learning model optimized with the hyperparameter random search can show improved results when observing the MAPE on the training and validation dataset. A summary of the two architectures and the performance is illustrated in Table 7.

TABLE 7

| | Baseline | Improved |
|---|---|---|
| Model Parameter | Model | Model |
| MLP Hidden Layer 1 Neurons | 8 | 54 |
| MLP Hidden Layer 2 Neurons | 4 | 54 |
| Number of Filters in Convolutional Layer 1 | 16 | 24 |
| Number of Filters in Convolutional Layer 2 | 32 | 4 |
| CNN Hidden Layer 1 Neurons | 16 | 32 |
| CNN Hidden Layer 2 Neurons | 4 | 32 |
| Hidden Layer 1 Neurons | 10 | 54 |
| Hidden Layer 2 Neurons | 5 | 12 |
| Training MAPE (%) | 16 | 15 |

Both the baseline model and the improved model performed similarly with the training data; the improved model performed better on the validation data as illustrated in Table 8.

TABLE 8

| Model Parameter | Baseline Model | Improved Model |
|---|---|---|
| Validation MAPE (%) | 22 | 17 |

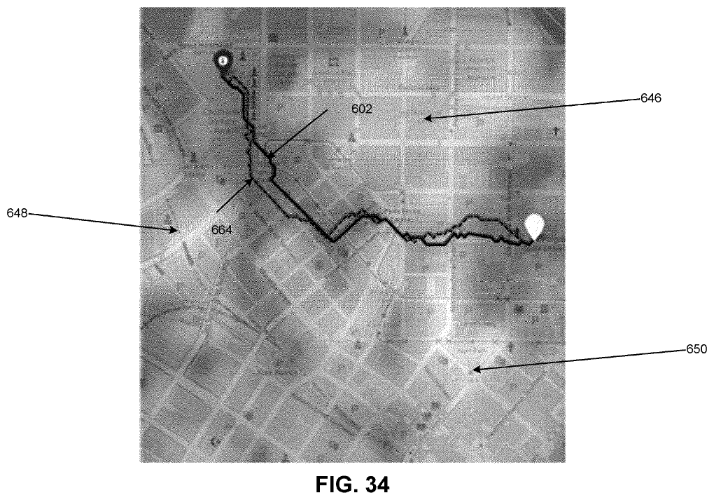

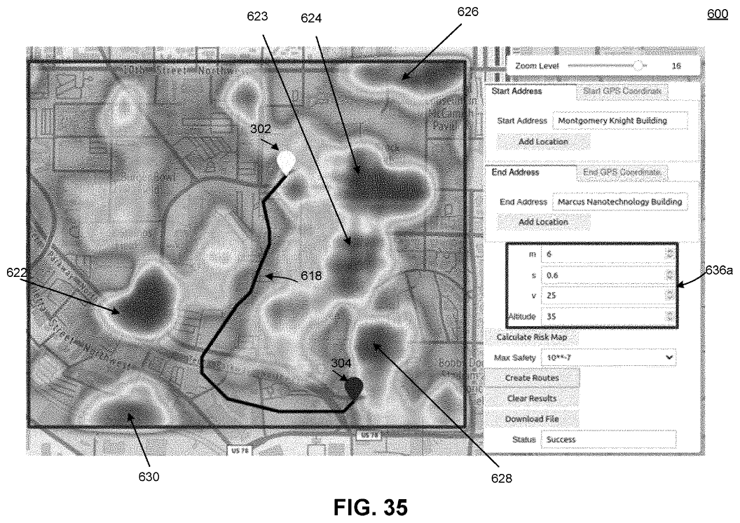

A reference is how made to comparison of the physics-based model with the machine learning models. A risk map can be created for the campus of the Georgia Institute of Technology using the daytime population density information from LandScan® combined with the collected social media activity. A UAS can have a mass of 6 kg, a frontal area of 0.6 m², a flight altitude of 35 m and a flight speed of 25 m/s operating over the campus. A risk map can be created using the physics-based model within several hours required for completion while the machine learning models can complete the risk map within several seconds using the same UAS conditions. Though the improved model performs better during training, the baseline model can perform better when compared to the risk map created by the physics-based model. When compared to the physics-based risk map, the MAPE for the baseline can be 19.3% while it can be 22.3% for the improved model, so the baseline model can be selected as a better model. A comparison between the risk map created using the baseline machine learning model and the physics-based risk map is illustrated in FIGS. 27 and 28. FIG. 27 illustrates the risk map created using the machine learning model. FIG. 28 illustrates the risk map created using the physics-based model. The heat map in each figure represents the expected fatality rate, measured as fatalities per flight hour. Areas 252, 254, 256, and 266 have population density about 1.5×10⁻⁶; areas 258, 260, 262, and 264 have population density about 2.0×10⁻⁶.

The comparison illustrates the machine learning can identify the substantially same high risk areas as the physics-based model, although the predicted risk from the machine learning model in these high risk areas appears to be less than from the physics-based model. However, the MAPE for the machine learning model creating such risk map can be about 19%. If the physics-based model determines the risk for a single location as 1×10⁻⁶ fatalities per flight hour, then the machine learning model may predict the risk value to be 0.81×10⁻⁶ fatalities per flight hour. The physics-based model can have one fatality every 114 years compared to a predicted 0.81 fatalities every 114 years for the ML model. Having such low frequency, the 19% MAPE can be deemed as reasonable. In some embodiments, the risk of the UAS to cause physical harm to people, livestock, etc. and/or damage valuable structures (e.g., buildings) or property can be used instead of or in addition to the fatality rate.

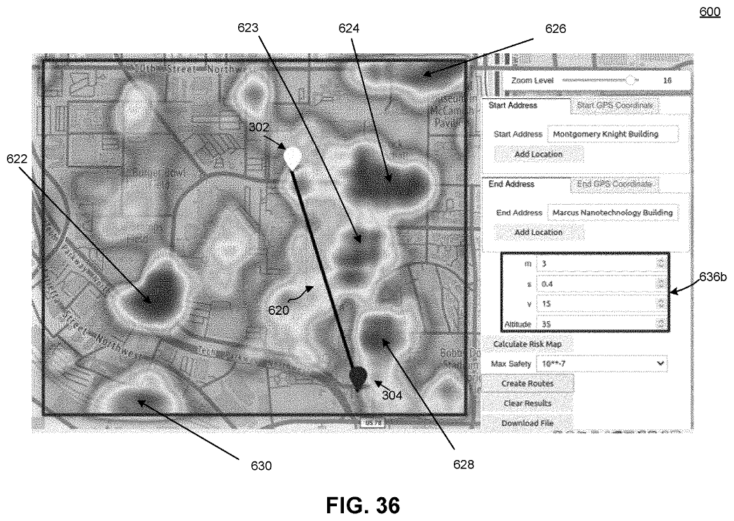

A benefit of using the machine learning model can be the rapid generation of the risk maps for UAS users to identify how the UAS flight conditions may affect the risk. FIGS. 29 and 30 illustrate two different risk maps created for two different UAS configurations.

FIG. 29 is a risk map created using the machine learning model for a low risk UAS: mass is 2 kg, frontal area is 0.4m², speed is 25 m/s, altitude is 35 m. Areas 368, 270, 272 have population density about 1.25×10⁻⁶.

FIG. 30 is a risk map created using the machine learning model for a high risk UAS: mass is 8 kg, frontal area is 0.75 m², speed is 30 m/s, altitude is 35 m. Areas 274, 276, 278, 280, 282, 284, 286 have population density about 1.50×10⁻⁶.

By changing the UAS flight conditions and UAS parameters, UAS pilots can observe how the risk map changes. A larger and faster UAS increases the risk compared to a smaller and slower UAS. This ability to rapidly create risk maps with changing UAS flight parameters can assist UAS pilots in the route planning to ensure the maximum level of allowable safety is not exceeded.

A risk-informed route planning solution can use population density and building coverage to reduce the time spent flying over people and increase the time spent over buildings that can provide coverage to people on the ground. The route algorithm can account for physical obstacles, e.g., tall buildings and no fly zones specified by the FAA facility maps when finding suitable routes.

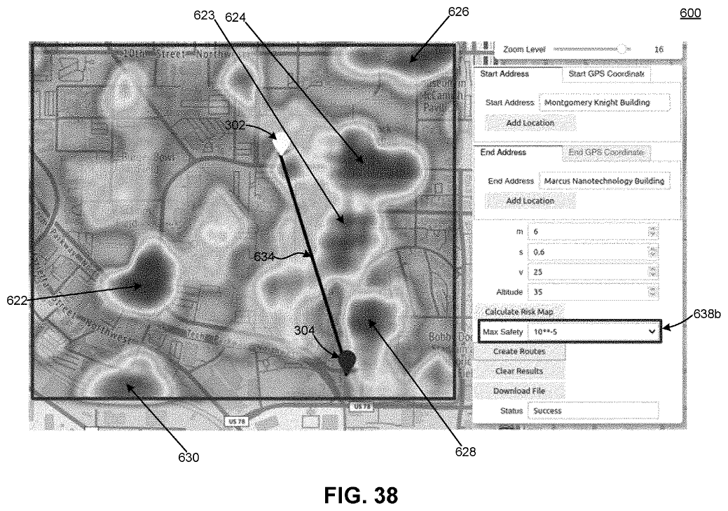

As described herein, a modified version of the A* algorithm can be used. The modification of the A* algorithm can change the heuristic function used in the A* algorithm to be a weighted combination of safety and distance. The algorithm can be used to identify a combination of the safest route or the fastest route as desired by the user. The machine learning model can be used to create a risk map that can be used by the route planning algorithm. Using the risk map this allows the algorithm to find the safest route based on reducing the risk of the path. The route planning algorithm can be used to find the safest route between at least two points at the location of interest using both risk maps created by the physics-based model and the machine learning model to compare the resulting paths. The comparison of the created routes is illustrated in FIG. 31 where the route 604 is the route created using the physics-based risk map and the route 602 is the route created using the machine learning model. The heat map in the figure is the risk map associated with the machine learning model. Higher risk areas 606, 608, 610, 612, 614 and 616 can have, for example, higher population density than other areas in the heat map.

The two routes created using each of the risk maps (e.g., the physics-based model and the ML model) are similar; the machine learning model is adequate to replace the physics-based model to facilitate the route planning. Comparison of the predicted risk and actual risk of the created route using the machine learning risk map is illustrated in Table 9. The predicted risk values and actual risk values can be the risk values obtained using the machine learning risk map and physics-based risk map, respectively.

TABLE 9

| | | | Absolute Percent |
|---|---|---|---|
| Risk | Predicted | Actual | Error (%) |
| Maximum Risk | 8.55 × 10⁻⁸ | 7.13 × 10⁻⁸ | 19.83 |
| (fatalities/hour) | | | |
| Average Risk | 1.72 × 10⁻⁸ | 1.79 × 10⁻⁸ | 4.19 |
| (fatalities/hour) | | | |

Table 9 illustrates that the error between the predicted maximum risk level and the actual risk level is greater than the error of the predicted average risk and the actual average risk. The machine learning model has a higher error with the higher risk areas 606-606, the ML model can identify the high risk regions, correctly avoid the higher risk areas 606-616 when facilitating the route planning. The error between the predicted average risk and the actual average risk is low; if the route planner attempts to avoid the higher risk areas 606-616, the predicted risk values can be close to the actual risk values. Both routes have a maximum risk value less than the acceptable risk level of 10⁻⁷.

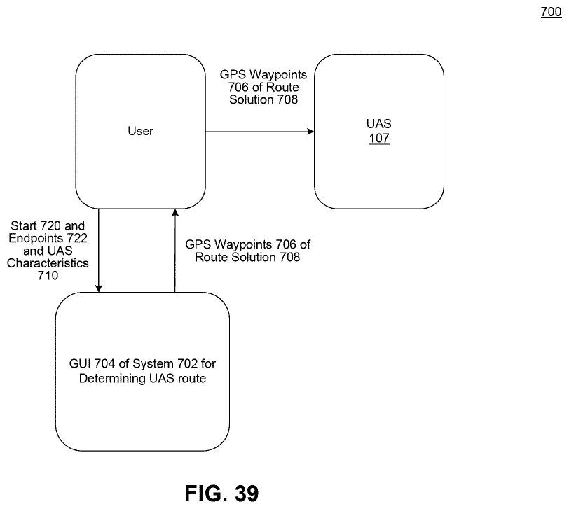

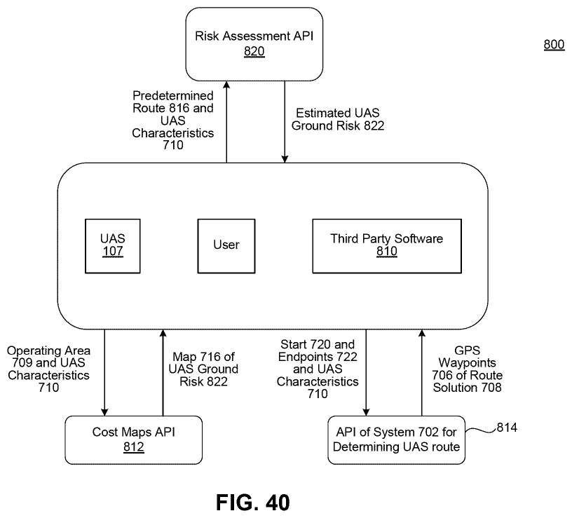

FIGS. 32-34 illustrate generalization of the ML model. FIG. 32 illustrates a heatmap obtained using the ML model. FIG. 33 illustrates a heatmap obtained using the physics-based model. When the ML model is applied to a different part of the city that has higher population densities and that was not used in training of the ML model, MAPE of 62% was output for the new area. For example, areas 642 and 644 in FIG. 33 (showing the output obtained using the physics-based model) have higher population densities than areas 646, 648, and 650 in FIG. 32 (showing the output obtained using the ML model). Such output can be a result of higher population densities than found at the training location.

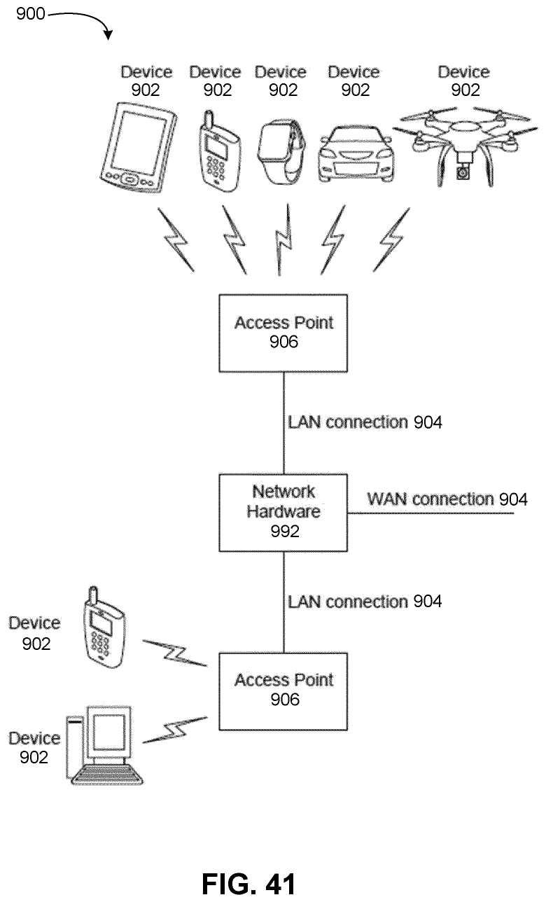

FIG. 34 illustrates routing solutions provided by the ML model and the physics-based model. The routing solution 662 from the ML model is similar to the routing solution 664 based on the physics-based model. Table 10 illustrates maximum and mean risks for predicted and actual cases as well as MAPE for these risks. The ML model is relatively accurate to provide the route planning solution for the UAS to fly in less populated areas.

TABLE 10

| | Predicted | Actual | MAPE (%) |
|---|---|---|---|
| Max Risk | 1.8e⁻⁷ | 2.39e⁻⁷ | 24.4 |
| (fatalities/flight hour/ | | | |
| Mean Risk | 6.14e⁻⁸ | 5.88e⁻⁸ | 4.5 |
| (fatalities/flight hour) | | | |

FIGS. 35 and 36 illustrate user interface (UI) wireframes of an application that can be for example, installed on a computing system or a web-based application to create routes for UAS users. Using the web-based user interface, a UAS user can enter the desired start 302 and endpoint 304 for the UAS, and the user interface can display the resulting route and can allow the user to download the list of GPS waypoints for the UAS to follow. The machine learning model can allow users to input the desired start and end points 302 and 304, respectively and use the desired UAS flight characteristics to create a more informed risk assessment. The user can also specify the maximum level of the required safety. FIGS. 35 and 36 display the user interface 600 and routes 618, 620 created using two different UAS configurations/characteristics 636a, 636b with a desired maximum risk level less than 10⁻⁷ fatalities per flight hour. In some embodiments, the risk of the UAS to cause physical harm to people, livestock, etc. and/or damage valuable structures (e.g., buildings) or property can be used instead of or in addition to the fatality rate.

The UAS user can adjust the target level of safety based on the industry application. For example, in some embodiments used by law enforcement and first responders, response time may be prioritized over safety level, e.g., it can be justified to relax the maximum level of safety may be. Using the user interface, the UAS user can introduce the respective changes to emphasize the arrival time. FIGS. 37 and 38 illustrate the resulting routes 632, 634 created for the same UAS configuration but having different levels of the required safety 638a, 638b. The route 634 that allows for higher rates of fatality takes a more direct path than route 632 over at least one of the higher risk areas 622-630. In some embodiments, the risk of the UAS to cause physical harm to people, livestock, etc. and/or damage valuable structures (e.g., buildings) or property can be used instead of or in addition to the fatality rate.

FIGS. 39 and 40 illustrate implementations 700 and 800 of the system 702 for determining a route by the UAS 107. In configuration 700 illustrated in FIG. 39, a user can input the start and end points 720 and 722, respectively, and/or the UAS characteristics 710 to a graphical user interface (GUI) 704 of the system 702 for determining the UAS route. In some embodiments, the system 702 can generate GPS waypoints 706 of one or more route solutions 708 and display it on the system GUI to the user. A user can select the route that satisfies the user requirements and instruct the system 702 to transmit the GPS waypoints 706 of the selected route solution 708 to the UAS 107.

In FIG. 40 illustrates a configuration 800 of the system 702 using the API for transmitting the data. For example, a risk assessment API 820 can communicate to the UAS 107, the user, or a third party software 810. In some embodiments, cost mapping API 812 and/or API 814 of the system 702 for determining the UAS route can communicate to at least one of the UAS 107, the user, or the third party software 810. In some embodiments, the UAS 107, the user, or the third party software 810 sends a predetermined route 816 and the UAS characteristics 710 to the risk assessment API and receives an estimated UAS ground risk 822 from the risk assessment API 820.

In some embodiments, the UAS 107, the user, or the third party software sends operating area 709 (e.g., the start and end points 720 and 722, respectively) and the UAS characteristics 710 to the cost mapping API 812 and receives a map 716 of the UAS ground risk 822 from the cost mapping API. In some embodiments, the UAS 107, the user, or the third party software 810 sends the start and end points 720 and 722, respectively, and/or the UAS characteristics 710 to the API 814 of the system 702 for determining the UAS route. In some embodiments, the UAS 107, the user, or the third party software 810 receives the GPS waypoints 706 of the selected route solution 708 from the API 814 of the system 702 for determining the UAS route.

The software application of the system 702 can provide UAS pilots a more efficient way to plan risk-informed routes flexible to their needs. The user interface can be designed to be intuitive and relatively easy to use. UAS users in law enforcement and delivery companies, can utilize the system for determining the UAS route described herein to create safe routes. The machine learning model allows a relatively quick risk assessment to ensure any planned route does not exceed a maximum level of allowable safety without taking significant time to determine expected risk values. The machine learning model allows the UAS users to rapidly generate a ground risk map based on their desired UAS flight conditions. After generating such risk map, a route planner (at step 418, FIG. 5) can be used to find a path that does not exceed an allowable risk value set by the user. Such solution can be implemented in a flexible web-based application that can be used by a UAS pilot operating in highly populated areas.

Having discussed specific embodiments of the present solution, it may be helpful to describe aspects of the operating environment as well as associated system components (e.g., hardware elements) in connection with the methods and systems described herein. Referring to FIG. 41, an embodiment of a network environment is depicted. The network may include or be in communication with one or more storage area networks (SANs), security adapters, or Ethernet converged network adapters (CNAs). In brief overview, the network environment includes a wireless communication system that includes one or more access points 906, one or more wireless communication devices 902 and a network hardware component 992. The wireless communication devices 902 may, for example, include laptop computers 902, tablets 902, personal computers 902, wearable devices 902, vehicles 902 (e.g., automobiles, drones, smart vehicles, robotic units, and the like), video game consoles 902, cellular telephone devices 902, smart TV sets 902, Internet of Thing (IoT) devices 902, and any other electronic devices 902 capable of wireless communication. The details of an embodiment of wireless communication devices 902 and/or access point 906 are described in greater detail with reference to FIGS. 42 and 43. The network environment can be an ad hoc network environment, an infrastructure wireless network environment, a wired network coupled to a wireless network, a subnet environment, or a combination of the foregoing, in one embodiment.

The access points (APs) 906 may be operably coupled to the network hardware 992 via local area network connections. The network hardware 992, which may include one or more routers, gateways, switches, bridges, modems, system controllers, appliances, and the like, may provide a local area network connection for the communication system. Each of the access points 906 may have an associated antenna or an antenna array to communicate with the wireless communication devices in its area. The wireless communication devices may register with a particular access point 906 to receive services from the communication system (e.g., via a SU-MIMO or MU-MIMO configuration). For direct connections (e.g., point-to-point communications), some wireless communication devices may communicate directly via an allocated channel and communications protocol. Some of the wireless communication devices 902 may be mobile or relatively static with respect to the access point 906.

In some embodiments, an access point 906 includes a device or module (including a combination of hardware and software) that allows wireless communication devices 902 to connect to a wired network using Wi-Fi or other standards. An access point 906 may sometimes be referred to as a wireless access point (WAP). An access point 906 may be configured, designed and/or built for operating in a wireless local area network (WLAN). An access point 906 may connect to a router (e.g., via a wired network) as a standalone device in some embodiments. In other embodiments, an access point 906 can be a component of a router. An access point 906 can provide multiple devices access to a network. An access point 906 may, for example, connect to a wired Ethernet connection and provide wireless connections using radio frequency links for other devices 902 to utilize that wired connection. An access point 906 may be built and/or configured to support a standard for sending and receiving data using one or more radio frequencies. Those standards and the frequencies they use may be defined by the IEEE (e.g., IEEE 802.11 standards). An access point 906 may be configured and/or used to support public Internet hotspots, and/or on an internal network, to extend the network's Wi-Fi signal range.

In some embodiments, the access points 906 may be used for in-home or in-building wireless networks (e.g., IEEE 802.11, Bluetooth, ZigBee, any other type of radio frequency-based network protocol and/or variations thereof). Each of the wireless communication devices 902 may include a built-in radio and/or be coupled to a radio. Such wireless communication devices 902 and/or access points 906 may operate in accordance with the various aspects of the disclosure as presented herein to enhance performance, reduce costs and/or size, and/or enhance broadband applications. Each wireless communication device 902 may have the capacity to function as a client node seeking access to resources (e.g., data, and connection to networked nodes such as servers) via one or more access points.

The network connections may include any type and/or form of network and may include any of the following: a point-to-point network, a broadcast network, a telecommunications network, a data communication network, or a computer network. The topology of the network may be a bus, star, or ring network topology. The network may be of any such network topology as known to those ordinarily skilled in the art and capable of supporting the operations described herein. In some embodiments, various types of data may be transmitted via different protocols. In other embodiments, the same types of data may be transmitted via different protocols.

The communications device(s) 902 and access point(s) 906 may be deployed as and/or executed on any type and form of computing device, such as a computer, network device, or appliance capable of communicating on any type and form of network and performing the operations described herein. FIGS. 42 and 43 depict block diagrams of a computing device 900 useful for practicing an embodiment of the wireless communication device 902 or access point 906. As shown in FIGS. 42 and 43, each computing device 900 includes a central processing unit 921 and a main memory unit 922. As shown in FIG. 42, a computing device 900 may include a storage device 928, an installation device 916, a network interface 918, an I/O controller 923, display devices 924a-901n, a keyboard 926 and a pointing device 927, such as a mouse. The storage device 928 may include, without limitation, an operating system and/or software. As shown in FIG. 43, each computing device 900 may also include optional elements, such as a memory port 903, a bridge 970, one or more input/output devices 930a-930n (generally referred to using reference numeral 930), and a cache memory 940 in communication with the central processing unit 921.

The central processing unit (CPU) 921 is any logic circuitry that responds to and processes instructions fetched from the main memory unit 922. In many embodiments, the central processing unit 921 is provided by a microprocessor unit, such as those manufactured by Intel Corporation of Mountain View, California; those manufactured by International Business Machines of White Plains, New York; or those manufactured by Advanced Micro Devices of Sunnyvale, California. The computing device 900 may be at least based on any of these processors or any other processor capable of operating as described herein. The CPU can be a programmable parallel processor.

Other programmable parallel processors can include a graphics processing unit (GPU) and/or a neural processor. The GPU is a programmable parallel processor that can perform complex computations for graphics rendering and general-purpose computing tasks. The GPU consists of processing cores interconnected through a high-bandwidth memory interface and a bus system, enabling efficient parallel processing. The processing core of the GPU can be equipped with dedicated arithmetic logic units and memory caches, allowing for simultaneous execution of multiple computational threads. To improve graphics rendering pipelines, the GPU can incorporate the following hardware components: texture units and rasterizers. The GPU can employ optimized algorithms and data parallelism techniques to accelerate computations, resulting in superior performance compared to a conventional CPU. The GPU can be programmable using graphics APIs and parallel computing frameworks, enabling scientific simulations, machine learning, and data analytics.

The neural processing unit or the neural processor (NP) can be a programmable parallel processor designed to efficiently process neural networks and accelerate artificial intelligence computations. The NP can comprise a plurality of processing elements interconnected through a high-speed network-on-chip, enabling effective distribution and synchronization of computations. Each processing element of the NP can include dedicated memory, arithmetic logic units, and/or control units, allowing parallel execution of multiple neural network layers or tasks. The NP can employ optimized algorithms and dataflow architectures to achieve high-performance computations, reducing latency and power consumption. The NP can incorporate hardware accelerators for common neural network operations, such as matrix multiplications and/or convolutions, enhancing processing efficiency. The NP can support a wide range of neural network models and is programmable through software interfaces, enabling flexibility in adapting to various AI applications.

Main memory unit 922 may be one or more memory chips capable of storing data and allowing any storage location to be accessed by the microprocessor 921, such as any type or variant of Static random-access memory (SRAM), Dynamic random-access memory (DRAM), Ferroelectric RAM (FRAM), NAND Flash, NOR Flash and Solid-State Drives (SSD). The main memory 922 may be at least based on any of the above-described memory chips, or any other available memory chips capable of operating as described herein. In the embodiment shown in FIG. 42, the processor 921 communicates with main memory 922 via a system bus 950 (described in more detail below). FIG. 43 depicts an embodiment of a computing device 900 in which the processor communicates directly with main memory 922 via a memory port 903. For example, in FIG. 43 the main memory 922 may be DRAM.

FIG. 43 depicts an embodiment in which the main processor 921 communicates directly with cache memory 940 via a secondary bus, sometimes referred to as a backside bus. In other embodiments, the main processor 921 communicates with cache memory 940 using the system bus 950. Cache memory 940 typically has a faster response time than main memory 922 and is provided by, for example, SRAM, BSRAM, or EDRAM. In the embodiment shown in FIG. 43, the processor 921 communicates with various I/O devices 930 via a local system bus 950. Various buses may be used to connect the central processing unit 921 to any of the I/O devices 930, for example, a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 924, the processor 921 may use an Advanced Graphics Port (AGP) to communicate with the display 924. FIG. 43 depicts an embodiment of a computer or computer system 900 in which the main processor 921 may communicate directly with I/O device 930b, for example via HYPERTRANSPORT, RAPIDIO, or INFINIBAND communications technology. FIG. 43 also depicts an embodiment in which local busses and direct communication are mixed: the processor 921 communicates with I/O device 930a using a local interconnect bus while communicating with I/O device 930b directly.

A wide variety of I/O devices 930a-930n may be present in the computing device 900. Input devices include keyboards, mice, trackpads, trackballs, microphones, dials, touch pads, touch screen, and drawing tablets. Output devices include video displays, speakers, inkjet printers, laser printers, projectors, and dye-sublimation printers. The I/O devices may be controlled by an I/O controller 923 as shown in FIG. 42. The I/O controller may control one or more I/O devices such as a keyboard 926 and a pointing device 927, e.g., a mouse or optical pen. Furthermore, an I/O device may also provide storage and/or an installation medium 916 for the computing device 900. In still other embodiments, the computing device 900 may provide USB connections (not shown) to receive handheld USB storage devices such as the USB Flash Drive line of devices manufactured by Twintech Industry, Inc., of Los Alamitos, California.

Referring again to FIG. 42, the computing device 900 may support any suitable installation device 916, such as a disk drive, a CD-ROM drive, a CD-R/RW drive, a DVD-ROM drive, a flash memory drive, tape drives of various formats, USB device, hard-drive, a network interface, or any other device suitable for installing software and programs. The computing device 900 may further include a storage device, such as one or more hard disk drives or redundant arrays of independent disks, for storing an operating system and other related software, and for storing application software programs such as any program or software 920 for implementing (e.g., software 920 configured and/or designed for) the systems and methods described herein. In some embodiments, any of the installation devices 916 could be used as the storage device. In some embodiments, the operating system and the software can be run from a bootable medium.

Furthermore, the computing device 900 may include a network interface 918 to interface to the network 904 through a variety of connections including, but not limited to, standard telephone lines, LAN or WAN links (e.g., 802.11, T1, T3, 56kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, IEEE 802.11ac, IEEE 802.11ad, CDMA, GSM, WiMax and direct asynchronous connections). In one embodiment, the computing device 900 communicates with other computing devices 900 via any type and/or form of gateway or tunneling protocol such as Secure Socket Layer (SSL) or Transport Layer Security (TLS). The network interface 918 may include a built-in network adapter, network interface card, PCMCIA network card, card bus network adapter, wireless network adapter, USB network adapter, modem, or any other device suitable for interfacing with the computing device 900 to any type of network capable of communication and performing the operations described herein.

In some embodiments, the computing device 900 may include or be connected to one or more display devices 924a-924n. As such, any of the I/O devices 930a-930n and/or the I/O controller 923 may include any type and/or form of suitable hardware, software, or combination of hardware and software to support, enable or provide for the connection and use of the display device(s) 924a-924n by the computing device 900. For example, the computing device 900 may include any type and/or form of video adapter, video card, driver, and/or library to interface, communicate, connect, or otherwise use the display device(s) 924a-924n. In one embodiment, a video adapter may include multiple connectors to interface to the display device(s) 924a-924n. In other embodiments, the computing device 900 may include multiple video adapters, with each video adapter connected to the display device(s) 924a-924n. In some embodiments, any portion of the operating system of the computing device 900 may be configured for using multiple displays 924a-924n. One ordinarily skilled in the art will recognize and appreciate the various embodiments and ways that a computing device 900 may be configured to have one or more display devices 924a-924n.

In further embodiments, an I/O device 930 may be a bridge between the system bus 950 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a FibreChannel bus, a Serial Attached small computer system interface bus, a USB connection, or a EIDMI bus.

A computing device or system 900 of the sort depicted in FIGS. 42 and 43 may operate under the control of an operating system, which controls scheduling of tasks and access to system resources. The computing device 900 can be running any operating system, such as any of the versions of the MICROSOFT WINDOWS operating systems, the different releases of the Unix and Linux operating systems, any version of the MAC OS for Apple computers, any embedded operating system, any real-time operating system, any open source operating system, any proprietary operating system, any operating systems for computing devices, or any other operating system capable of running on the computing device and performing the operations described herein. Typical operating systems include, but are not limited to, Android, produced by Google Inc.; WINDOWS 7 and 8, produced by Microsoft Corporation of Redmond, Washington; MAC OS, produced by Apple Computer of Cupertino, California; WebOS, produced by Research In Motion (RIM); OS/2, produced by International Business Machines of Armonk, New York; and Linux, a freely-available operating system distributed by Caldera Corp. of Salt Lake City, Utah, or any type and/or form of a Unix operating system, among others.

The computer system 900 can be any workstation, telephone, desktop computer, laptop or notebook computer, server, handheld computer, telephone or other portable telecommunications device, media playing device, a gaming system, computing device, or any other type and/or form of computing, telecommunications or media device that is capable of communication. The computer system 900 has sufficient processor power and memory capacity to perform the operations described herein.

In some embodiments, the computing device 900 may have different processors, operating systems, and input devices consistent with the device. For example, in one embodiment, the computing device 900 is a smart phone, mobile device, tablet or personal digital assistant. In still other embodiments, the computing device 900 is an Android-based device, an iPhone smart phone manufactured by Apple Computer of Cupertino, California, or a Blackberry or WebOS-based handheld device or smart phone, such as the devices manufactured by Research In Motion Limited. Moreover, the computing device 900 can be any workstation, desktop computer, laptop or notebook computer, server, handheld computer, telephone, any other computer, or other form of computing or telecommunications device that is capable of communication and that has sufficient processor power and memory capacity to perform the operations described herein. Aspects of the operating environments and components described above will become apparent in the context of the systems and methods disclosed herein.

It should be noted that certain passages of this disclosure can reference terms such as “first” and “second” in connection with devices signals, data, inputs, channels, and the like for purposes of identifying or differentiating one from another or from others. These terms are not intended to merely relate entities (e.g., a first input and a second input) temporally or according to a sequence, although in some cases, these entities can include such a relationship. Nor do these terms limit the number of possible entities (e.g., devices) that can operate within a system or environment.

It should be understood that the systems described above can provide multiple ones of any or each of those components. The systems and methods described above can be provided as one or more computer-readable programs or executable instructions, programmable circuits, or digital logic embodied on or in one or more articles of manufacture. The article of manufacture can be a floppy disk, a hard disk, a CD-ROM, a flash memory card, a PROM, a RAM, a ROM, ASIC, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

While the foregoing written description of the methods and systems enables one of ordinary skill to make and use various embodiments of these methods and systems, those of ordinary skill will understand and appreciate the existence of variations, combinations, and equivalents of the specific embodiment, method, and examples herein. The present methods and systems should therefore not be limited by the above-described embodiments, methods, and examples, but by all embodiments and methods within the scope and spirit of the disclosure.

What is claimed is:

1. A method for determining a route by an unmanned aerial system (UAS), the method comprising:
receiving at least two locations, a first location and a second location;
receiving UAS characteristics and spatial data;
outputting a map based on the UAS characteristics and the spatial data, the map indicating a fatality rate; and
outputting the route for the UAS to fly from the first location and the second location based on the map indicating the fatality rate.

2. The method of claim 1, wherein the route is configured to be modified in response to at least one of safety or urgency.

3. The method of claim 1, wherein the spatial data comprises at least one of:
a social media activity;
a density population;
an area of one or more buildings; and
a height of the one or more buildings.

4. The method of claim 1, wherein the UAS characteristics comprise at least one of:
a mass of the UAS;
a front area of the UAS;
a speed of the UAS; and
an altitude of the UAS.

5. The method of claim 1, further comprising:
receiving elevation data.

6. The method of claim 5, further comprising:
modifying the output route based on the elevation data.

7. The method of claim 1, wherein at least one of the locations, the UAS characteristics or the spatial data is configured to be defined by a user.

8. The method of claim 1, wherein the route is configured to be displayed on a user interface (UI).

9. The method of claim 1, wherein the fatality rate is based at least on one of:
an area exposed to an impact to a ground from a failure of the UAS; and
a probability of a fatality.

10. The method of claim 9, wherein the probability of the fatality is based at least on one of:
energy during the impact to the ground from the failure of the UAS; and
a sheltering factor.

11. The method of claim 10, wherein the sheltering factor is based at least on one of:
one or more trees; and
one or more buildings.

12. A system for determining a route by an unmanned aerial system (UAS), the system comprising:
one or more processors configured to:
receive at least two locations, a first location and a second location;
receive UAS characteristics and spatial data;
output a map based on the UAS characteristics and the spatial data, the map indicating a fatality rate; and
output the route for the UAS to fly from the first location and the second location based on the map indicating the fatality rate.

13. The system of claim 12, wherein the route is configured to be modified in response to at least one of safety or urgency.

14. The system of claim 12, wherein the route is configured to be modified in response to at least one of:
a social media activity;
a density population;
an area of one or more buildings; and
a height of the one or more buildings.

15. The system of claim 12, wherein the UAS characteristics comprise at least one of:
a mass of the UAS;
a front area of the UAS;
a speed of the UAS; and
an altitude of the UAS.

16. The system of claim 12, wherein at least one of the locations, the UAS characteristics or the spatial data is configured to be defined by a user.

17. The system of claim 12, wherein the route is configured to be displayed on a user interface (UI).

18. A non-transitory computer-readable medium storing a set of instructions for determining a route by an unmanned aerial system (UAS), the set of instructions comprising:
one or more instructions that, when executed by one or more processors of a device, cause the device to:
receive at least two locations, a first location and a second location;
receive UAS characteristics and spatial data;
output a map based on the UAS characteristics and the spatial data, the map indicating a fatality rate; and
output the route for the UAS to fly from the first location and the second location based on the map indicating the fatality rate.

19. The non-transitory computer-readable medium of claim 18, wherein the route is configured to be modified in response to at least one of safety or urgency.

20. The non-transitory computer-readable medium of claim 18, wherein the spatial data comprises at least one of:
a social media activity;
a density population;
an area of one or more buildings; and
a height of the one or more buildings.
